(19) United States
(12) Patent Application Publication
(10) Pub. No.: US 2024/0391609 A1
(43) Pub. Date: Nov. 28, 2024

(54) LAUNCH METHOD, LAUNCH DEVICE, ACCELERATION METHOD, MASS DRIVER, AND TRANSPORT SYSTEM

(71) Applicant: Katsuya NISHIZAWA, NAGANO (JP)

(72) Inventor: Katsuya NISHIZAWA, NAGANO (JP)

(21) Appl. No.: 18/792,621

(22) Filed: Aug. 2, 2024

Related U.S. Application Data
(63) Continuation-in-part of application No. PCT/JP2022/047797, filed on Dec. 25, 2022.

(30) Foreign Application Priority Data
Feb. 2, 2022 (JP) 2022-015274
May 26, 2022 (JP) 2022-086263
Nov. 14, 2022 (JP) 2022-181631

(51) Int. Cl. B64G 1/00; H05H 13/04

(52) U.S. Cl. CPC B64G 1/002; H05H 13/04

(57) ABSTRACT

Devise a method and launching device/launcher for launching into space from the ground or the air. In the accelerating method by the magnetic fluid and linear motor car proposed by the orbital ring system, there was a risk that the object could not be accelerated to orbital speed. This application shows idea that is using recoil or reaction that shoots, moves, emits, or reflects photons or charged particles.

The present invention relates to a launch device.

*This application is an application based on an idea.

Regarding the launch equipment, for example, in the proposal of accelerating the magnetic fluid with a known track Orbital Ring Systems or the proposal of accelerating it with a linear motor car (Non Patent document 1: Orbital Ring Systems and Jacob's Ladders), There was a risk that the object being launched would not be able to accelerate beyond its orbital speed exceeding 7 km/s.

### PRIOR ART DOCUMENTS

### Patent Document

Non Patent document 1 Paul Birch, “Orbital Ring Systems and Jacob's Ladders-I-III”

### SUMMARY OF THE INVENTION

### Problem to be Solved by the Invention

The launch method and launch equipment from the ground and the air to space are devised. In the accelerating method by the magnetic fluid and linear motor car proposed by the orbital ring system, there was a possibility that the object in the aforementioned system might not be accelerable to orbital velocity.

The goal is to devise a 2 MS launcher/accelerator for launching objects (into space) that is smaller in scale than the orbital ring and can accelerate beyond the orbital speed.

### Means for Solving the Problem

This application show idea that is firing a photon (synchrotron radiation) and accelerating using counteraction.

The momentum P of a photon is P=h×nu/c=h/ld (h: Planck's constant, nu: frequency, c: speed of light, ld: wavelength), so the wavelength when emitting light from the air plane 3, ld may also be considered; the shorter ld is, the larger P can be.

Photons with shorter wavelengths than ultraviolet and UV-C may have higher acceleration and propulsion power than red or infrared light. From the above considerations, it is claimed that photons with high momentum can be emitted and emitted in the present application, which is preferable for the use of the accelerator of the present application. Note that photons with wavelengths shorter than the UV-C include X-rays and gamma rays.

When using synchrotron radiation in a propulsion device or an acceleration device When accelerated high-energy charged particles are bent, they can emit photons (including X-rays, etc.) as synchrotron radiation.

The structure may use photons that are the synchrotron radiation to emit or emit photons. The structure may use the synchrotron radiation light in an accelerator or a propulsion device.

### Description of Problem-Solving Means Using FIGS. 1M and 1N

As an example, explanatory diagrams of a launch device are shown in FIGS. 1M and 1N.

FIGS. 1M and 1N shows launch device (2MS etc) have The structure (1, 2 etc). The structure (1,2) may use photons (300C) that are the synchrotron radiation to emit or emit photons (300C) from accelerator (30A)/accelerator device.

FIG. 1M shows that an explanatory diagram of a launch device that accelerates and launches a launch object using photons particles.

In the configuration shown in FIG. 1M, 300FOBJ has the characteristic of propelling itself by emitting photons backwards.

FIG. 1N shows that after the structure 2 (2MSCA) is accelerated and rotated using the photon particle method, the rotational speed of the launcher 2MSCA is applied to the launch object 300FOBJ loaded on the structure 2 (2MSCA) in the direction of the launch destination. It is an explanatory diagram of launching and releasing (towards space, etc.).

### Structure 2 Accelerated and Rotated Using Photons and Charged Particles (2MSCA)

As an example, acceleration and launch procedure of the launched object in FIG. 1M In FIG. 1M, the launched object emits photons and charged particles to accelerate and propel itself (or the launched object is irradiated with photons and charged particles, which are reflected and accelerated and propelled). In FIG. 1M, the launched object emits the photons to accelerate and propel itself.

As an example, acceleration and launch procedure of the launched object in FIG. 1N In FIG. 1N, the following example and procedure can be performed.
[Step 1]: Load the launch object 300FOBJ onto the annular launch device 2MSCA (or 2MS-SYS-SPIN) which is stationary (velocity V=zero) or has an initial velocity.

During the loading, the launch device 2MSCA and the launch object 300FOBJ may be connected and fixed.

The fixing mechanism (for example, 2MS-OBJLINK in FIG. 1N) may be able to release the fixing by electrical or mechanical control.

A combination of electromagnetic coupling means, mechanical joining/coupling means, frictional fixing means, and chemical coupling means such as adhesive may be used for the fixing mechanism.

When it is desired to release, a signal may be sent to the mechanism to weaken the joint/coupling.
[Step 2]: The launch device 2MSCA loaded with the launch object 300FOBJ is accelerated by the method using photons or charged particles. Let the speed after acceleration be VMS.
[Step 3]: Launch the launch object 300FOBJ from the launch device 2MSCA toward the launch target.

*In step 3, the structure (2) is spun/rotated/moved/motioned in step 2, and by releasing the fixation with the structure, the launch object flies away while preserving the rotational motion. (or The balance of forces that were in balance when the object was held in place is no longer balanced as the fixation is released, and the launched object is then released and flies far away due to the remaining force to continue rotating, centrifugal force, etc.)

In the case of linear launch device 2MSLA. Although the above procedure is described for annular launch device 2MSCA, it may also be applied to linear launch device 2MSLA, or a multi-stage launch device or spiral type launch device described later. Even a linear launch device 2MSLA can be used as the accelerator 2MSLA and the launch device 2MSLA in steps 1 to 2 and 3 if the distance of the trajectory that can be accelerated can be earned.

A spiral type launch device 2MS may be used if needed.

Multi-stage accelerator/launch device. The launch may be performed using a launch device 2MS or a launch system (2MS-SYS) having a multi-stage/multi-stage accelerator section.

A launch system that combines a main accelerator/accelerator unit, a front-stage accelerator/front-stage accelerator unit, a rear-stage accelerator/back-stage accelerator unit.

Deflection device. The launch device 2MS may be combined with a thrust deflection device, thrust vectoring device.

Thrust deflection device 30ATV (injection nozzle 30ATV) that adjusts the final launch direction during launch.

The launch device may be combined with a thrust deflection device, thrust vectoring device.

(<Platform> If possible, Instead of the annular structure 2/2MSCA or linear structure 2/2MSLA placed in the air in FIG. 1F, Arrange the launch device (2MS, 2MS, etc.: including linear launch device 2MSLA, circular launch device 2MSCA), The launch device 2MS is equipped with a connection part 17 (non-contact type or contact type connection part 17, device 17), Connecting part 17 and above-ground part 14 (and above-ground power grid/communication network) with cable 12, The launch device 2MS or the like may be used as a high-altitude launch platform or a communication platform with aerial the structure or space the structure.)

(The scope of the present invention is not limited. For example, one idea may include the ring-shaped aerial structure 2 of the orbital ring system of a satellite, the space structure 1 is connectable to the orbital ring system or section 17 and 14 using cable 12. Like FIG. 1B, FIG. 10, FIG. 11, etc. *Space development. *Peaceful use.)

Although embodiments of the invention have been described, these embodiments are presented by way of example and are not intended to limit the scope of the invention. These novel embodiments can be implemented in various other forms, and various omissions, substitutions, and changes can be made without departing from the gist of the invention.

### BRIEF DESCRIPTION OF DRAWINGS

FIG. 1 is shown across sheet 1 and sheet 2 and is an explanatory diagram showing the connector part 17 attached to the structure 2.

FIG. 1A An explanatory diagram of structure 2 and device 17/part 17.

FIG. 1B An explanatory diagram of the present application including 2 and 17 and the cable 12 (a diagram in which 17 and 12 may be part of an orbital/space elevator)

FIG. 1C is shown across sheet 5 and sheet 6 which is an explanatory diagram of the connector part 17 hanging from the structure 2, surrounding the structure 2 with 17, connecting 17 to 2 by magnetic attraction, controlling 317C and 171C, and guiding 17.

FIG. 1D is shown across sheet 7 and sheet 8 which is an idea diagram 17 In the case of FIG. 1C, when 17TRs are present. A diagram of connecting 17TR to 2 with magnetic attraction, controlling 317 and 317C/171C, magnetically attracting them, propelling them, and guiding them.

FIG. 1E is shown across sheet 9 and sheet 10 which is an idea diagram of connecting the connector part 17 to another “connector 17-structure 2” pair in the structures 2 and 17 of the present application.

FIG. 1F is shown across sheet 11 and sheet 12 wherein the structure 2 is located above the ground or ocean and is connected to the connector part 17 using cable 12. (power transmission, communication using cable 12 is shown)

FIG. 1G is shown across sheet 13, sheet 14 and sheet 15 which is a diagram including the case where the structure 2 receives particle or laser radiation from U1A on the ground in

FIGS. 1F and 1s propelled by a sail (Explanatory diagram of receiving photons from outside the structure 2 and propelling it by the photon sail.)

FIG. 1H is shown across sheet 16, sheet 17 and sheet 18 which is a diagram in which a plurality of laser/particle irradiation parts of the structure 2 are irradiated toward a target object, the target objects 15 and 3 are propelled, and the debris target object is removed.

FIG. 1I is shown across sheet 19 and sheet 20 wherein 17TR is accelerated in the acceleration tube of structure 2. (Example of configuration of 17TR when the annular 17TR shown by the broken line in the upper part of FIG. 1 is attached to structure 2)

FIG. 1J An explanatory diagram when structures 2 and 17 are magnetically attracted.

FIG. 1K An explanatory diagram of how to respond when ring type structures 2 and 1 increase in length in the circumferential direction when the altitude increases (explanatory diagram of 39 and 39CVR)

FIG. 1L is shown across sheet 23, sheet 24 and sheet 25 which is an explanatory diagram of air plane 3, structure 2, structure 1 changing the emission direction of photons/particles by the deflection means 30ATV.

FIG. 1M is shown across sheet 26, sheet 27 and sheet 28 which is an explanatory diagram of the launch equipment (2MS, 2MSLA, 2MSCA, 2MS-SYS-LAUNCHER).

FIG. 1N is shown across sheet 29 and sheet 30 which is an explanatory diagram of the launch equipment (2MS, 2MSCA, 2MS-SYS-SPIN, etc).

FIG. 2 Examples of where structures are placed.

FIG. 3 is shown across sheet 32 and sheet 33 which is an Example of an accelerator using photons of the structure of the present application.

FIG. 4 is shown across sheet 34 and sheet 35 which is an Example of an accelerator in the structure. <When particles, bullets, and objects are accelerated in an acceleration tube using an electric field/magnetic field>

FIG. 5 is shown across sheet 36 and sheet 37 which is an Example of an accelerator in the structure. <Case where multiple elements of the accelerator are provided>

FIG. 6 Example of internal device relationship diagram of the accelerator having the structure.

FIG. 7 Examples of flight devices and propulsion devices for flight of aircraft 3, air planes 3, and solar planes 3. (some may be used in conjunction with accelerators)

FIG. 8 An explanatory diagram of the aircraft 3, air planes 3, and solar planes 3.

FIG. 9 An explanatory diagram of structure 1 or structure 2.

FIG. 10 An explanatory idea diagram of space structure 1 for one example.

FIG. 11 An explanatory idea diagram of Lifting device of space structure 1 for one example.

FIG. 12 is shown across sheet 44 and sheet 45 which is an explanatory idea diagram of space structure 1, showcasing an explanatory idea diagram for accelerating and decelerating particle flow 300F for one example. <Example of MHD power generation unit/MHD accelerator>

FIG. 13 An explanatory launch flowchart and mission flowchart of structure for one example.

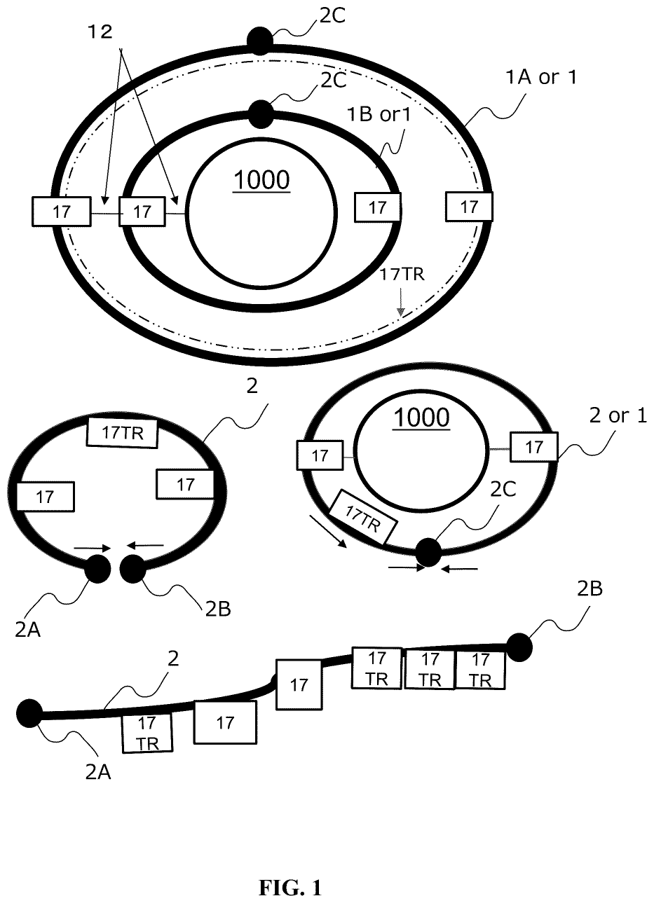

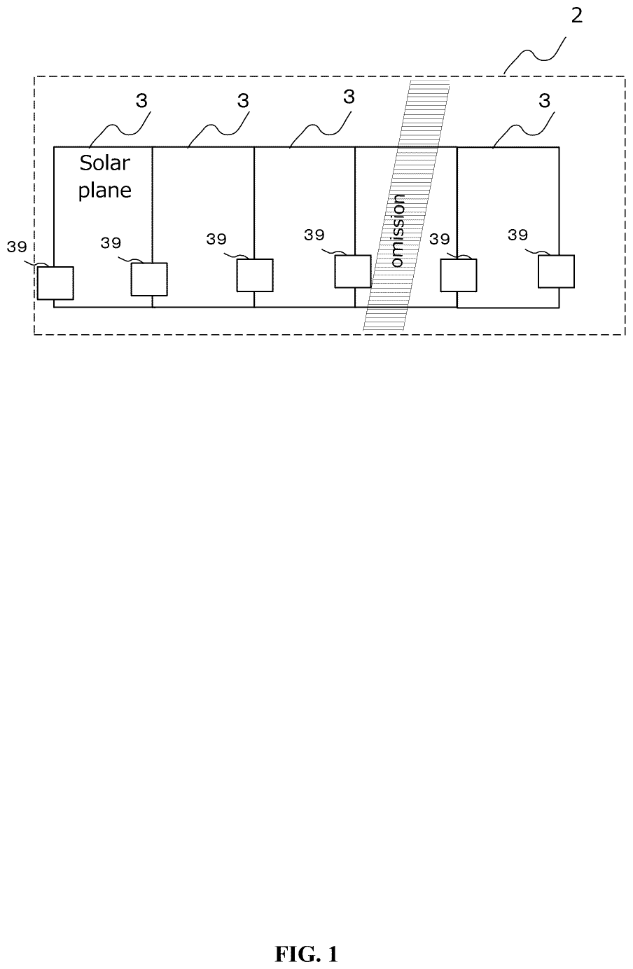

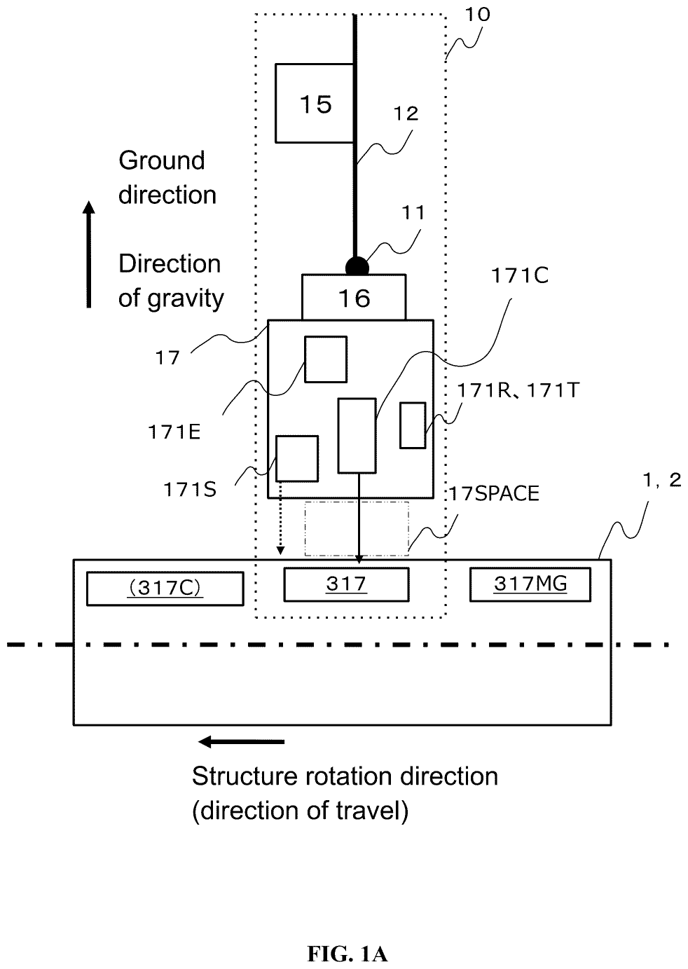

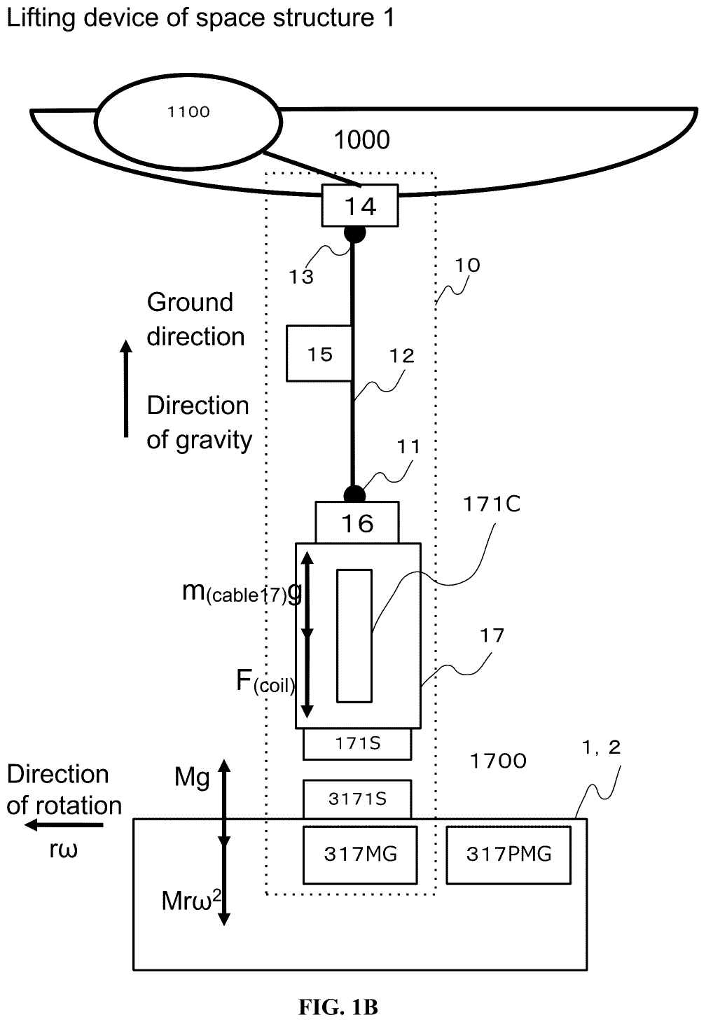

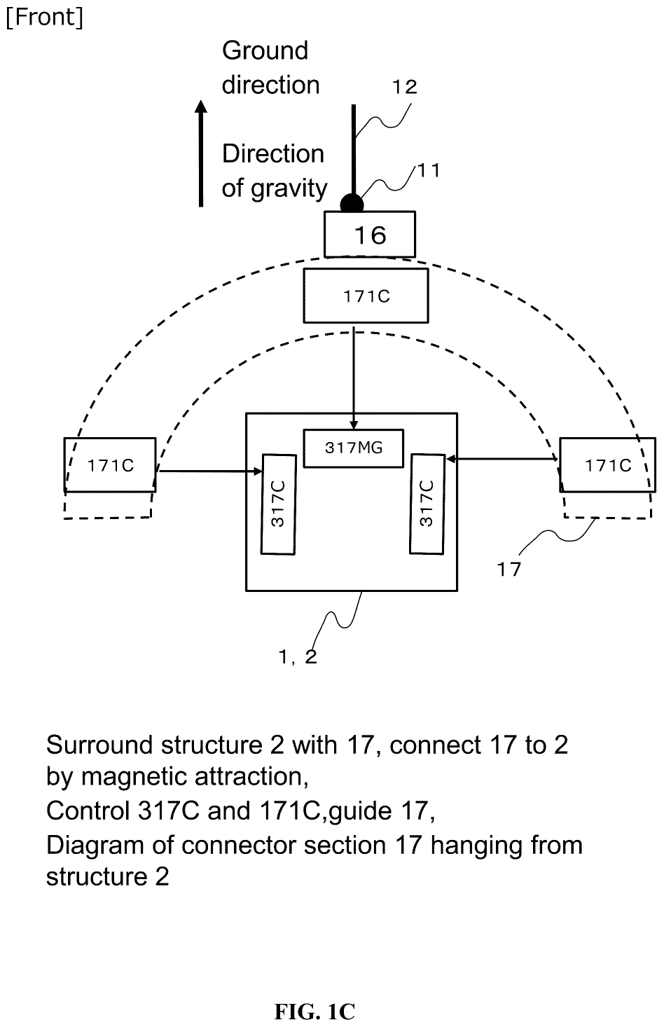

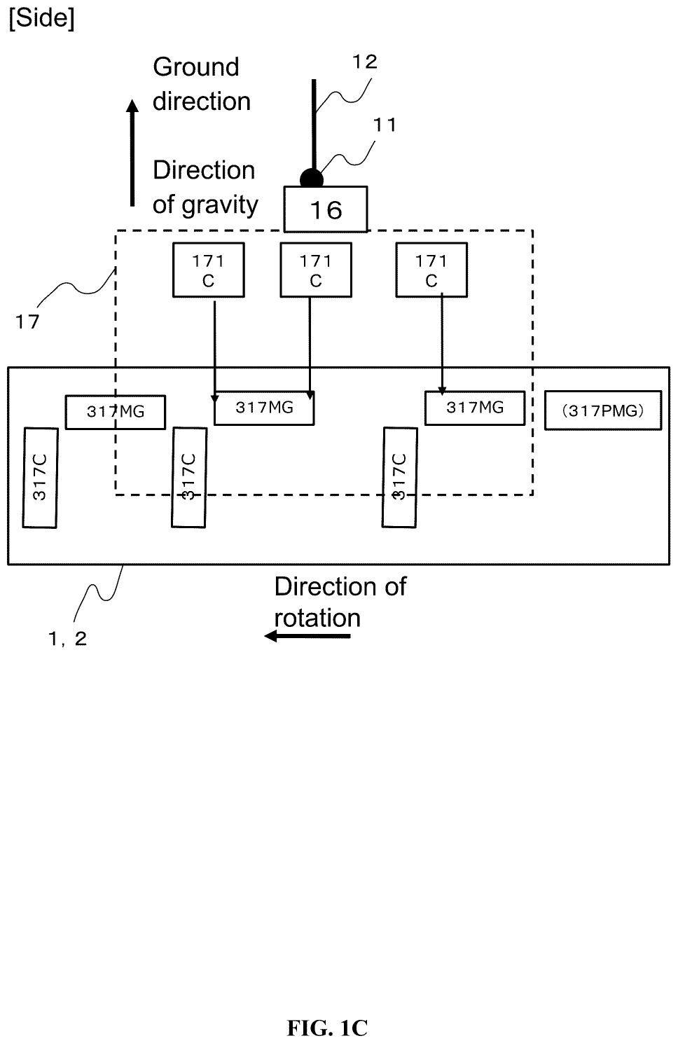

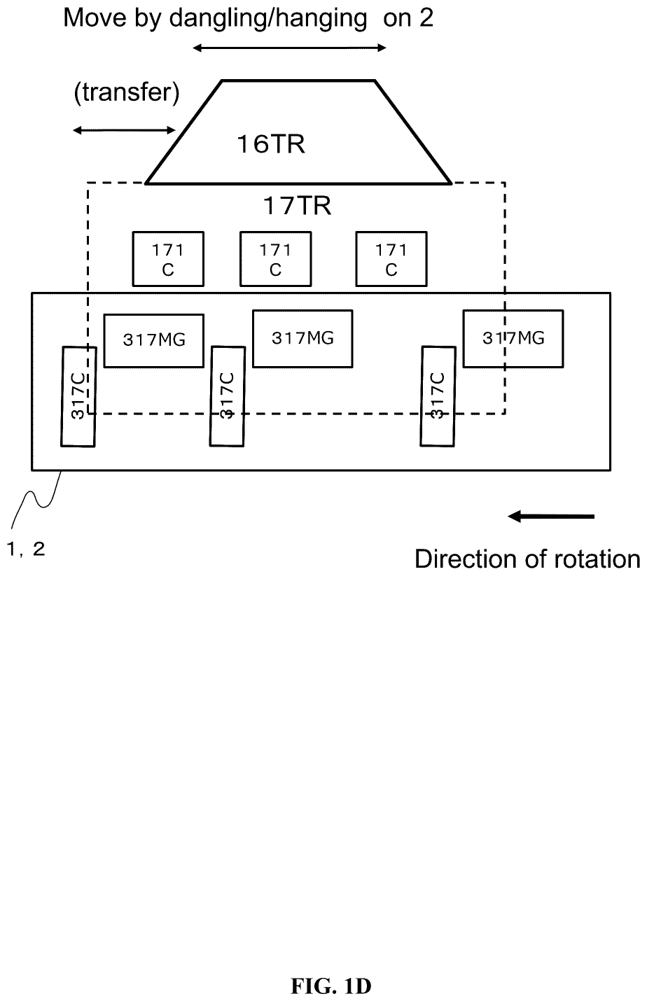

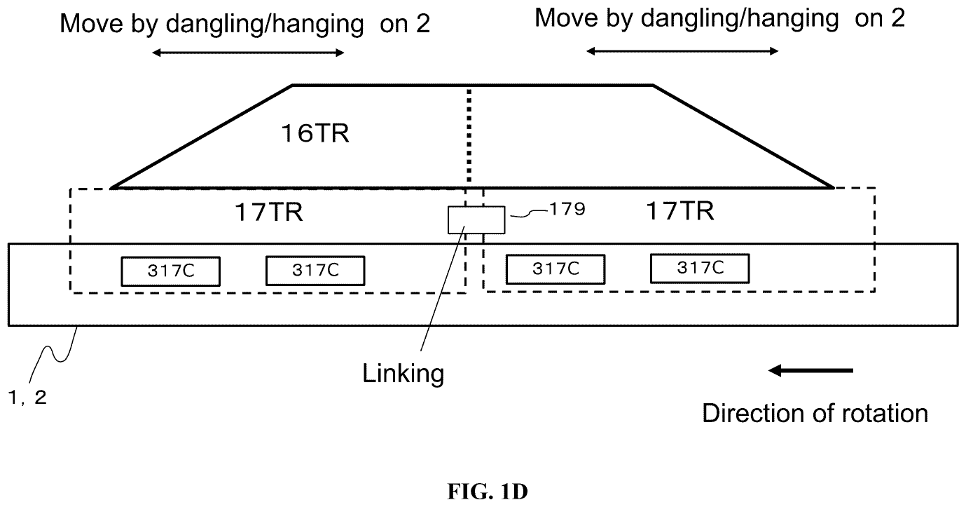

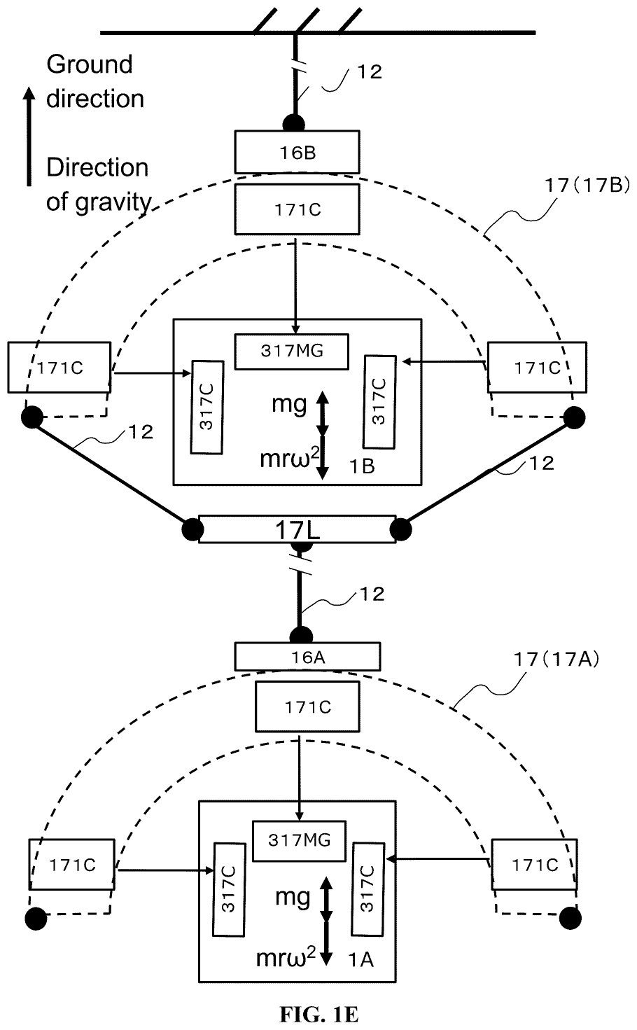

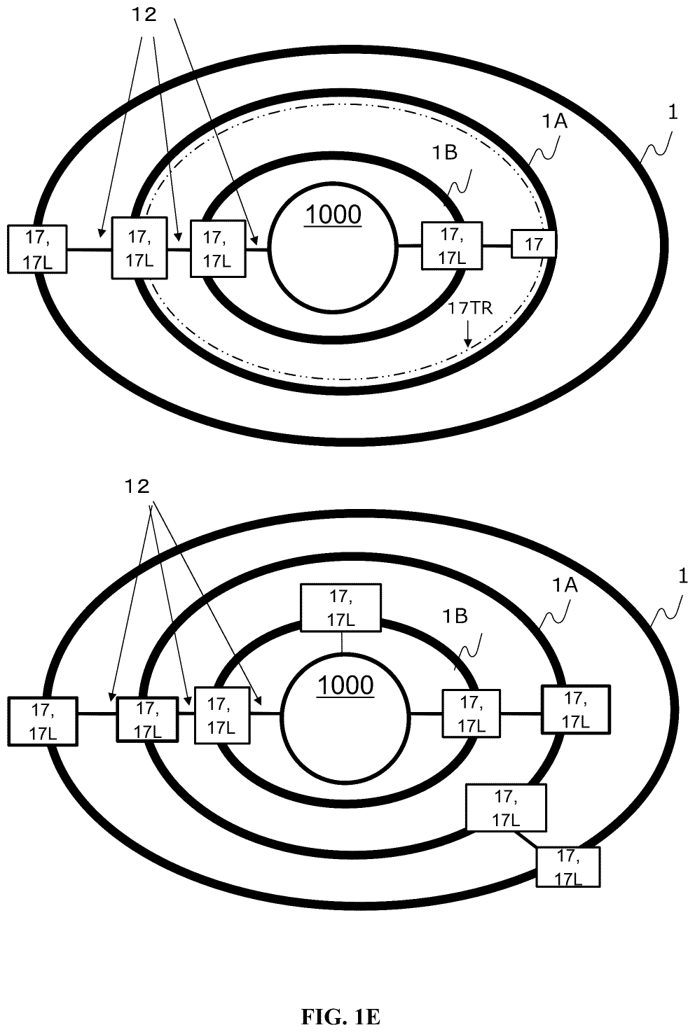

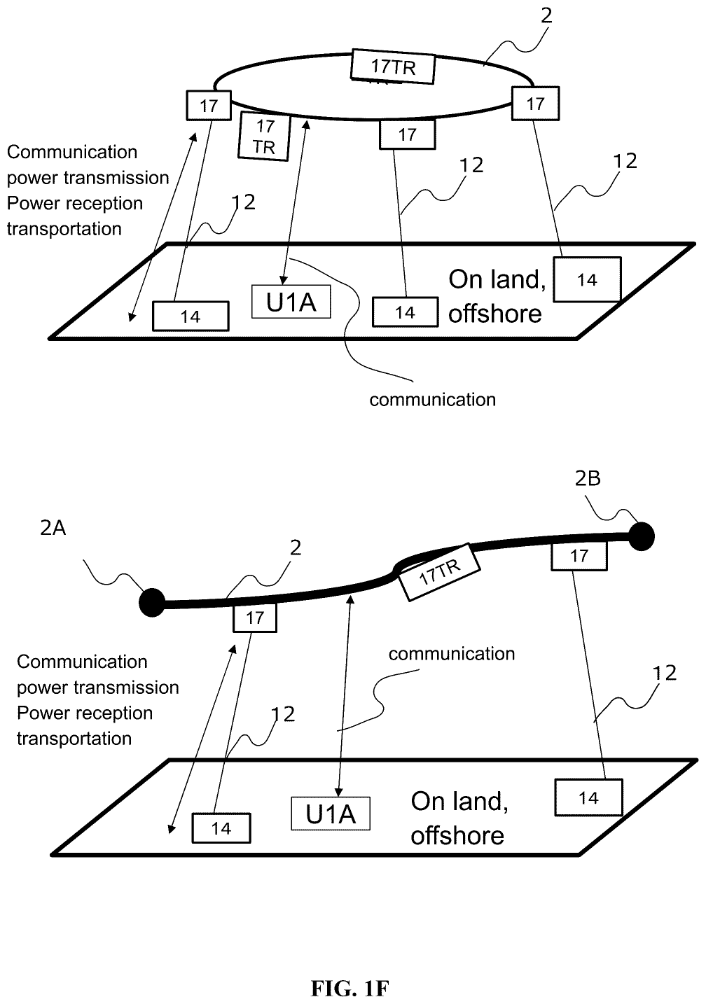

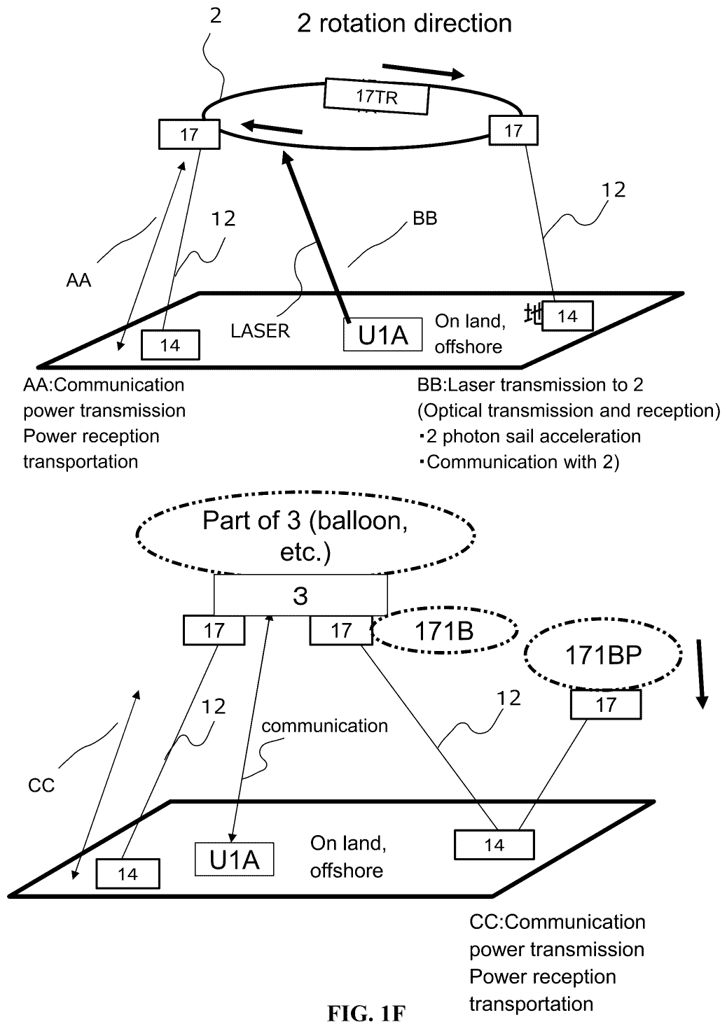

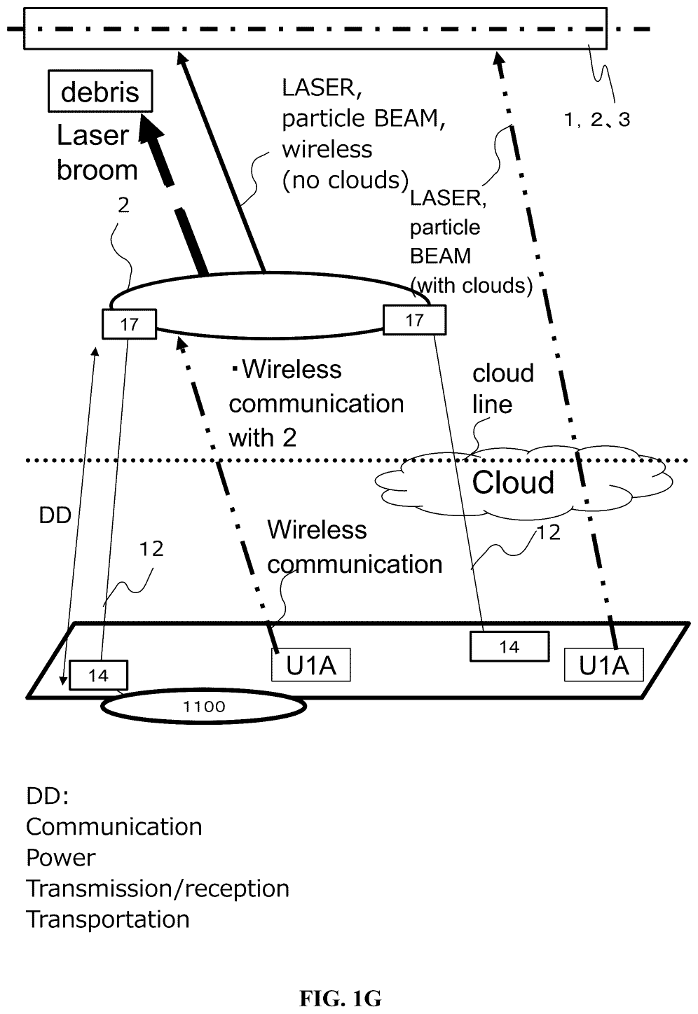

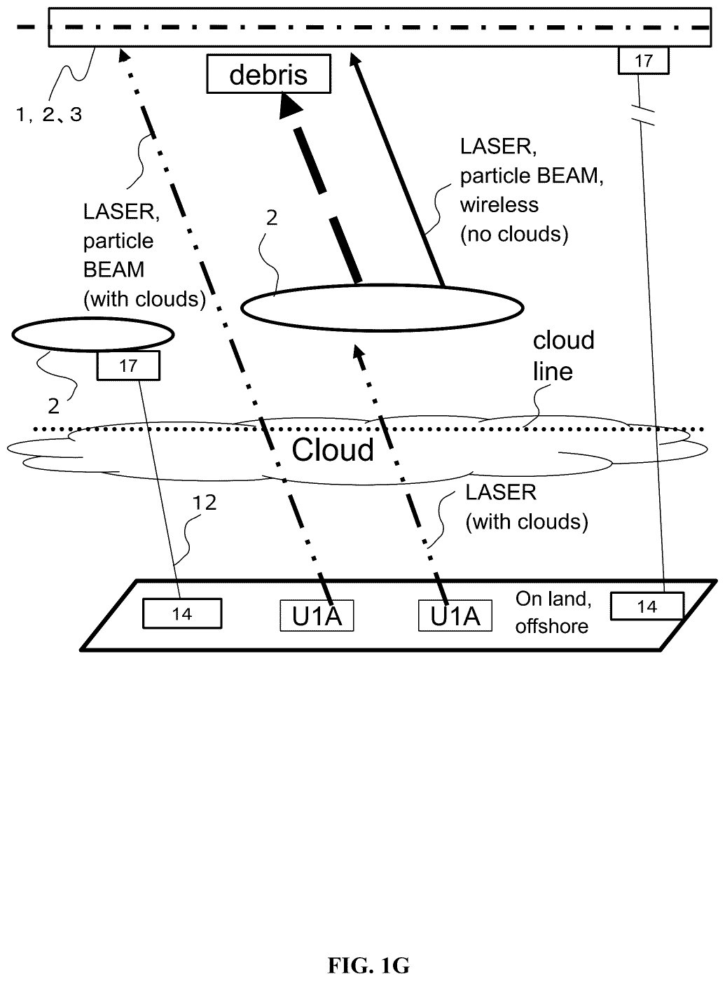

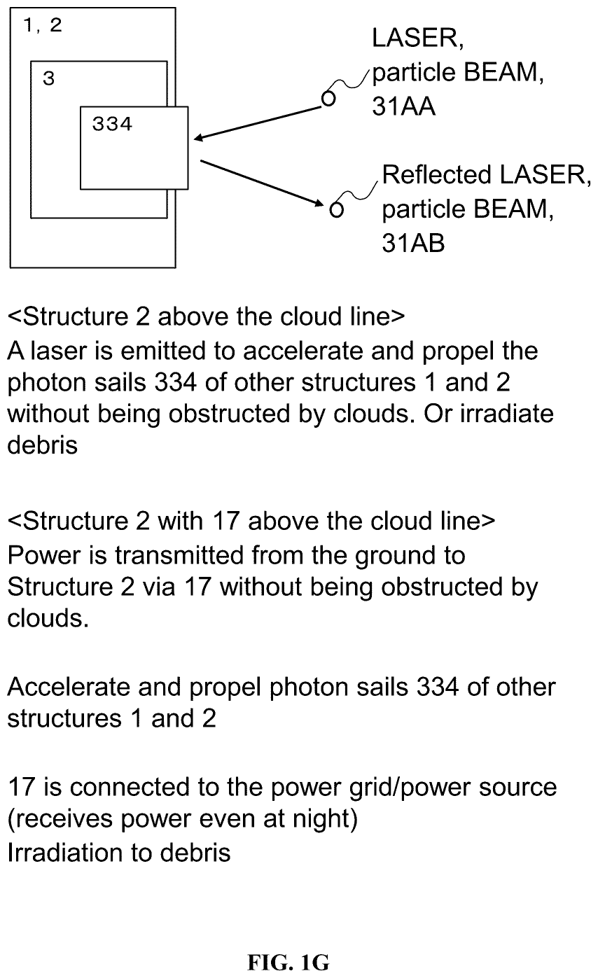

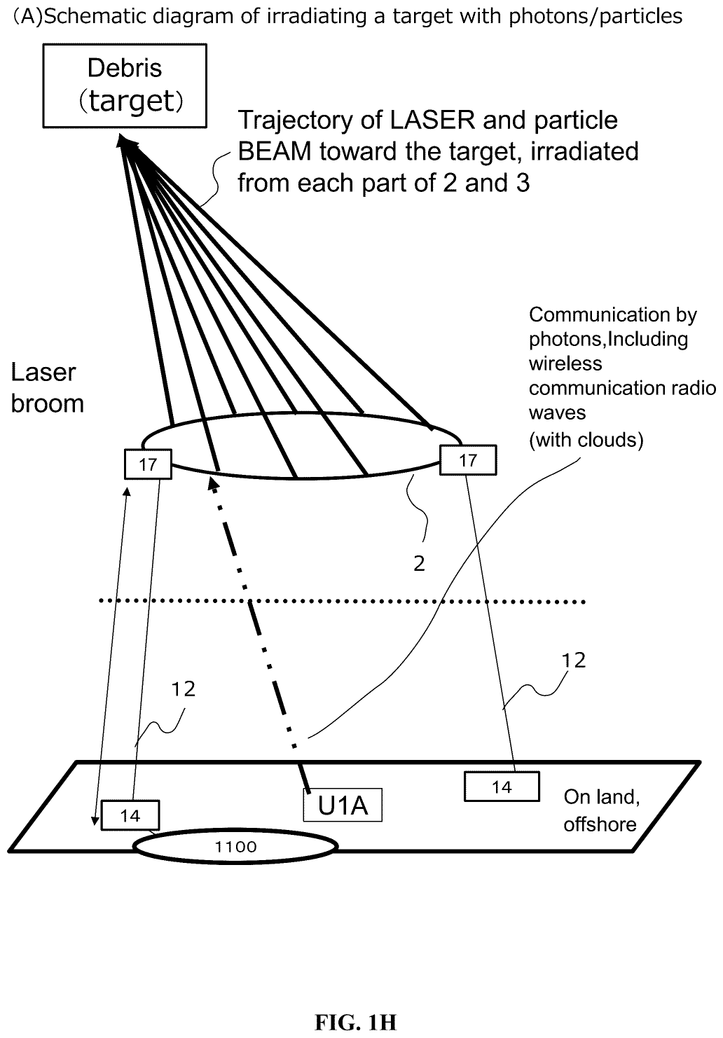

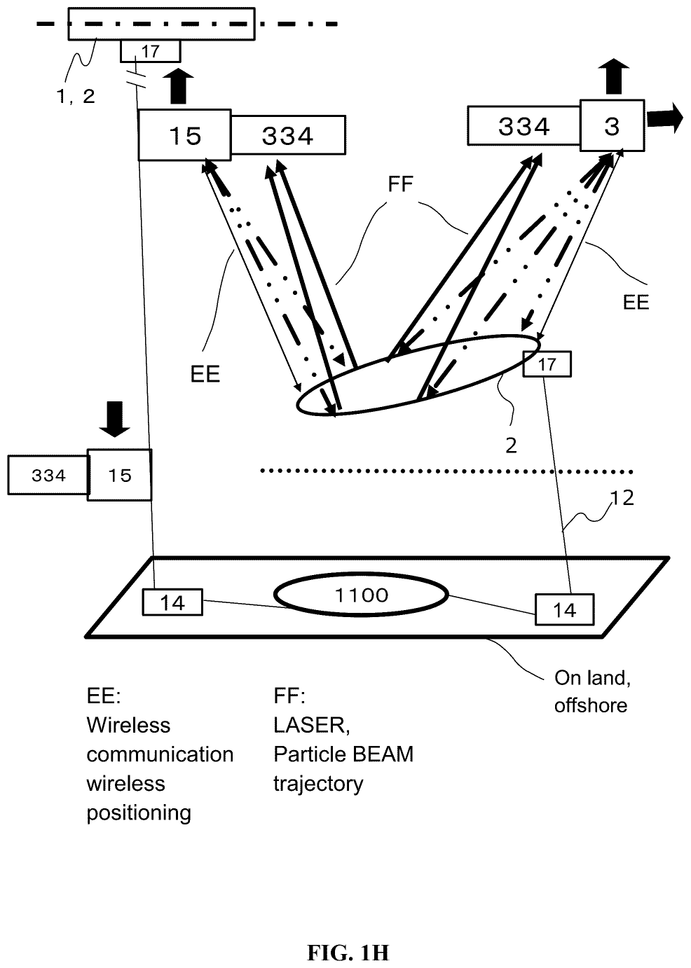

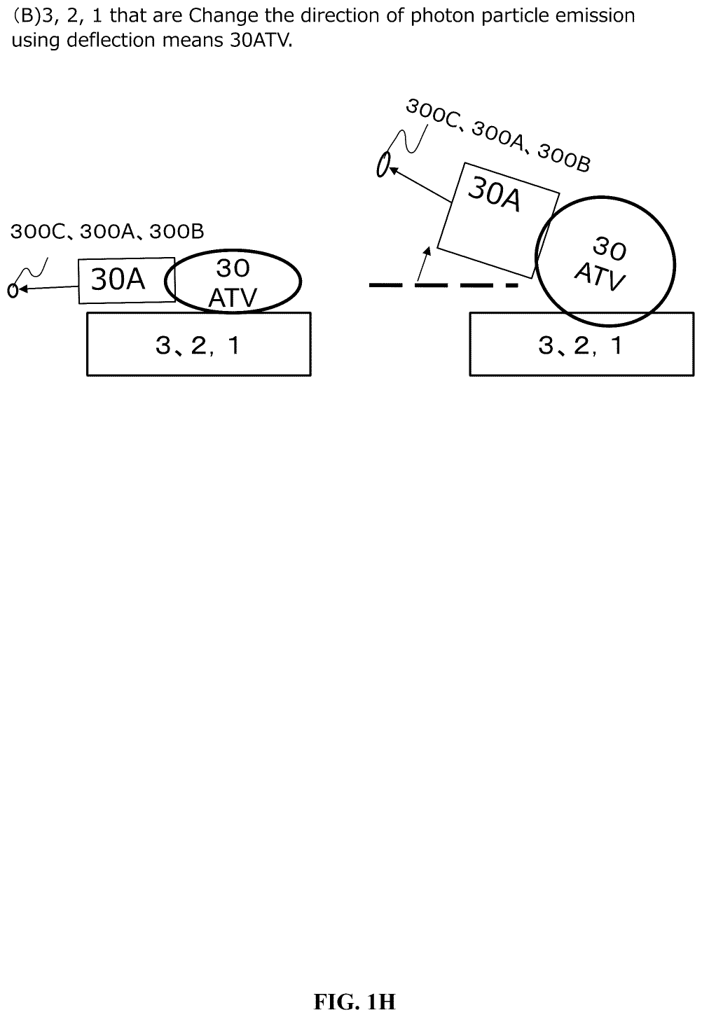

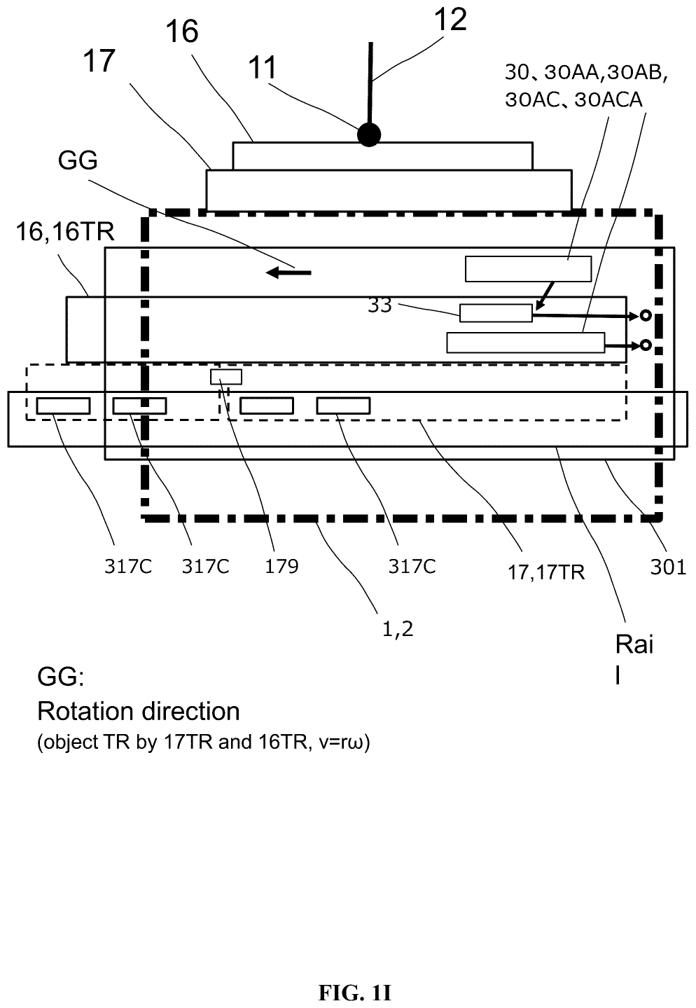

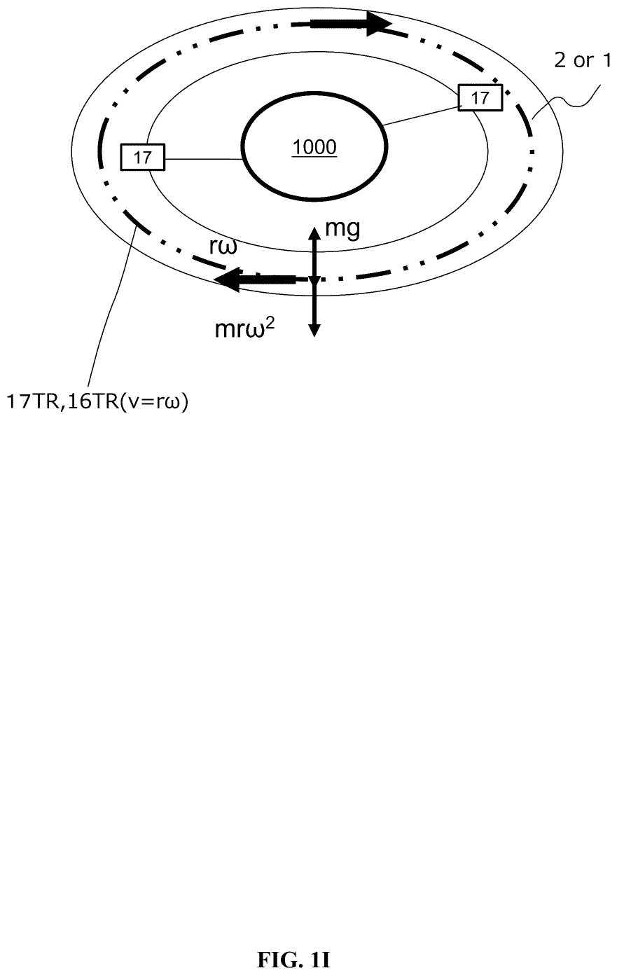

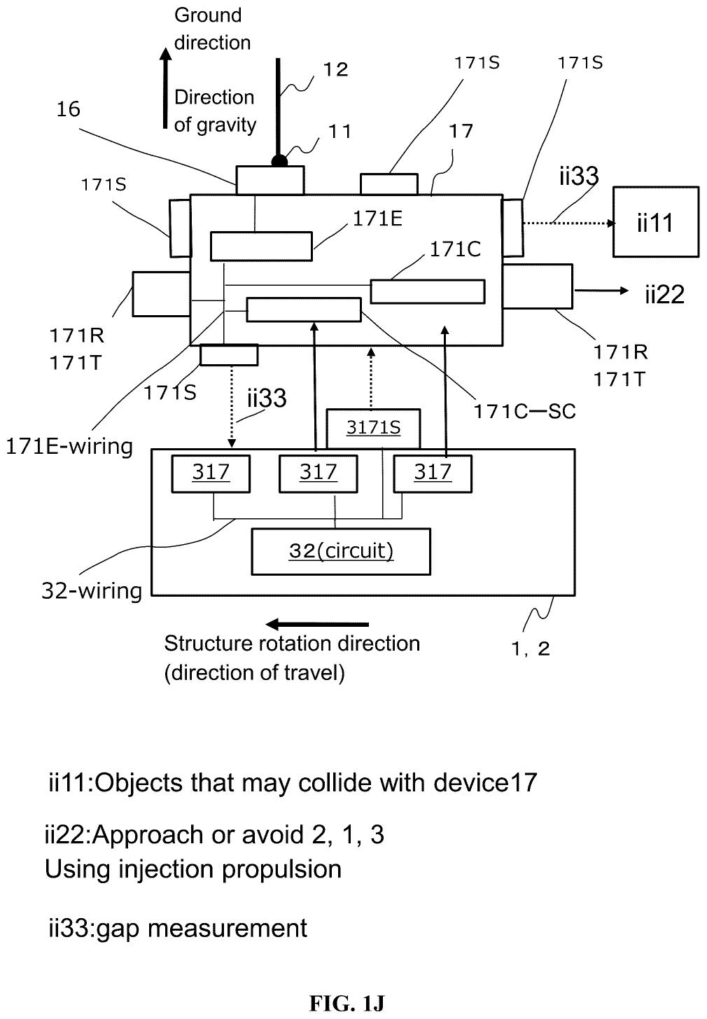

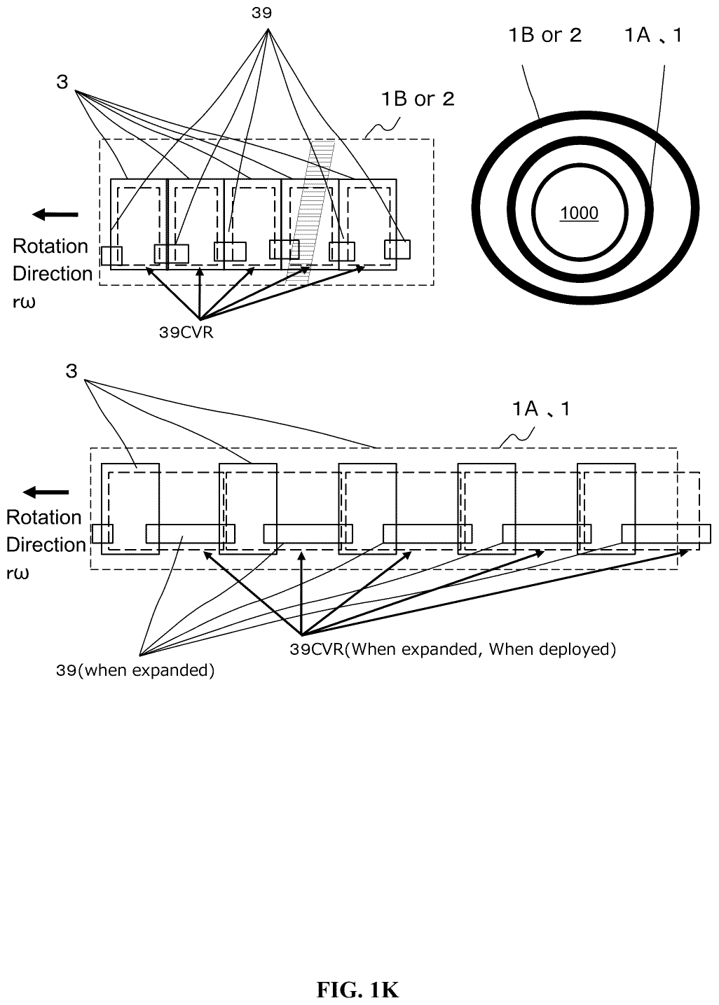

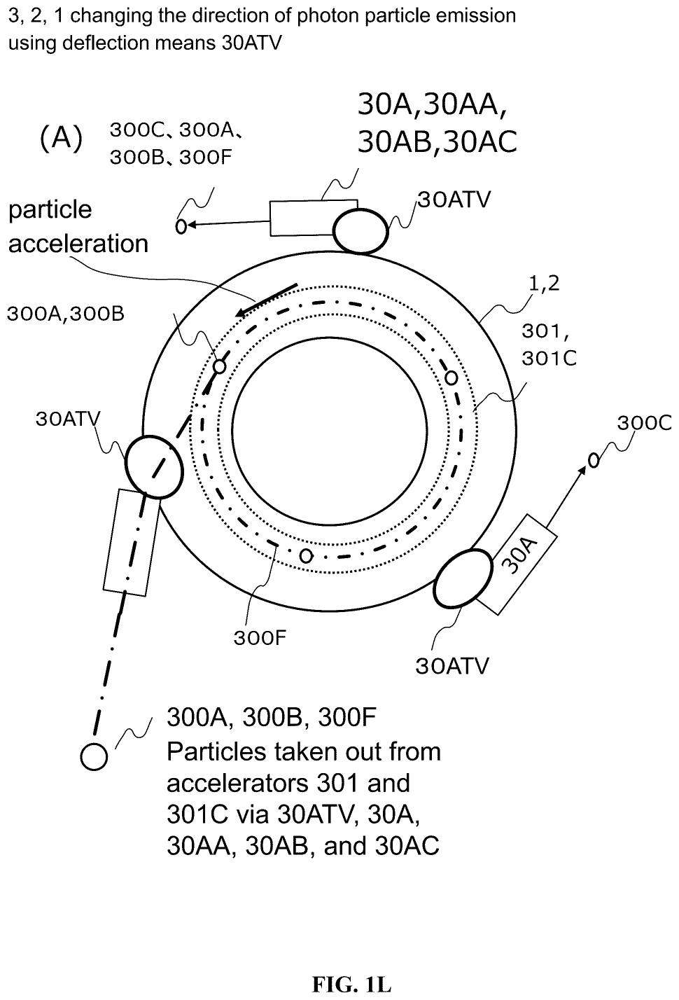

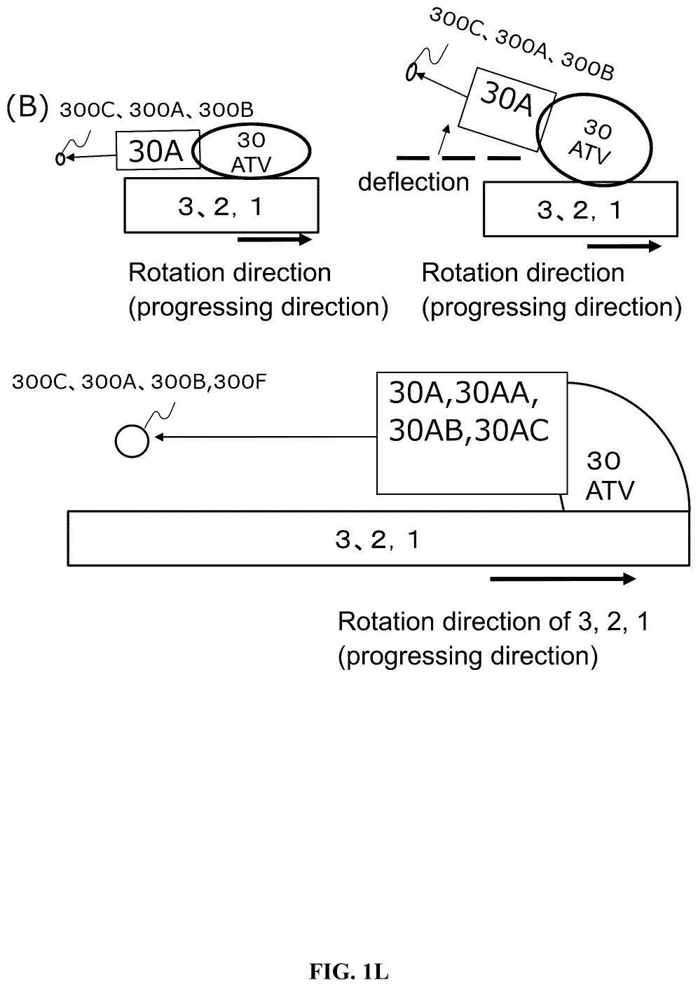

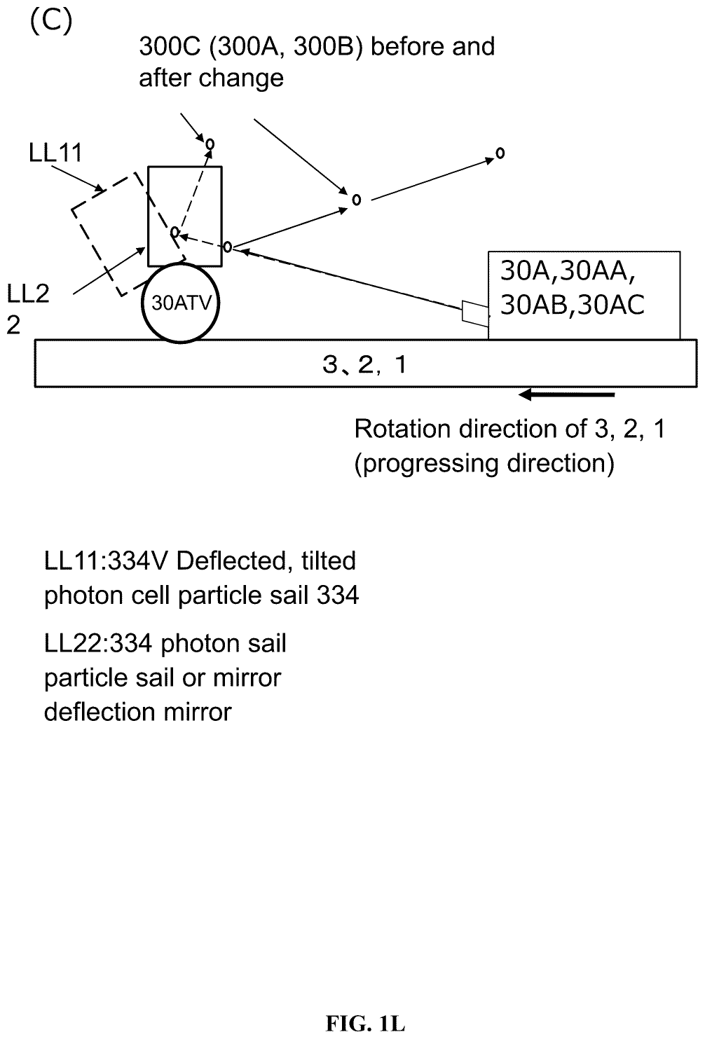

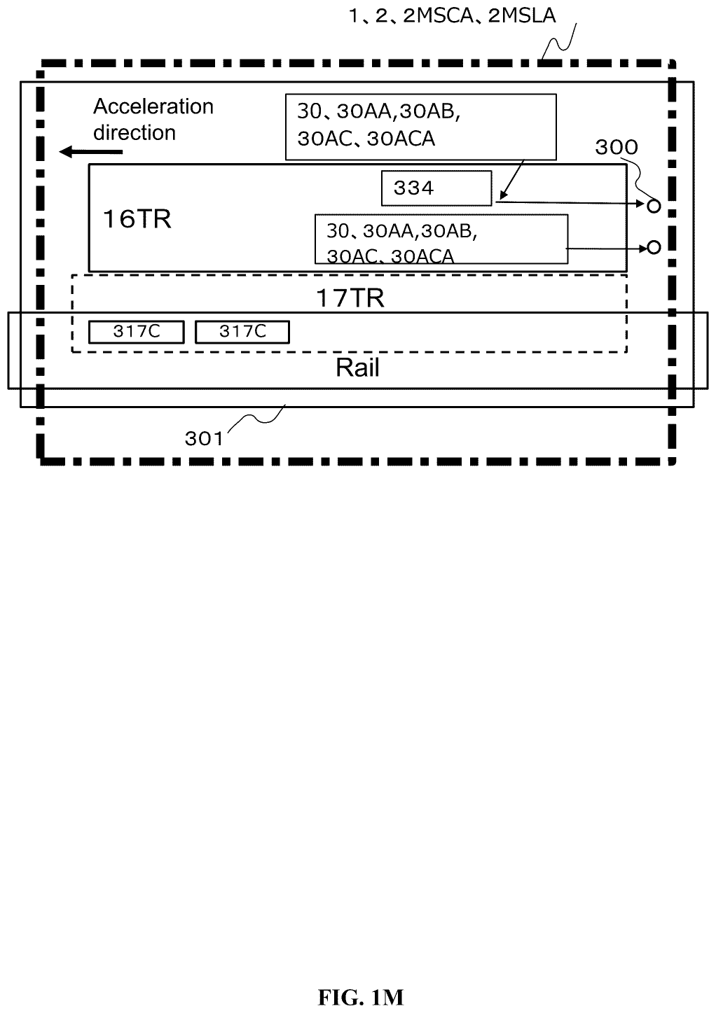

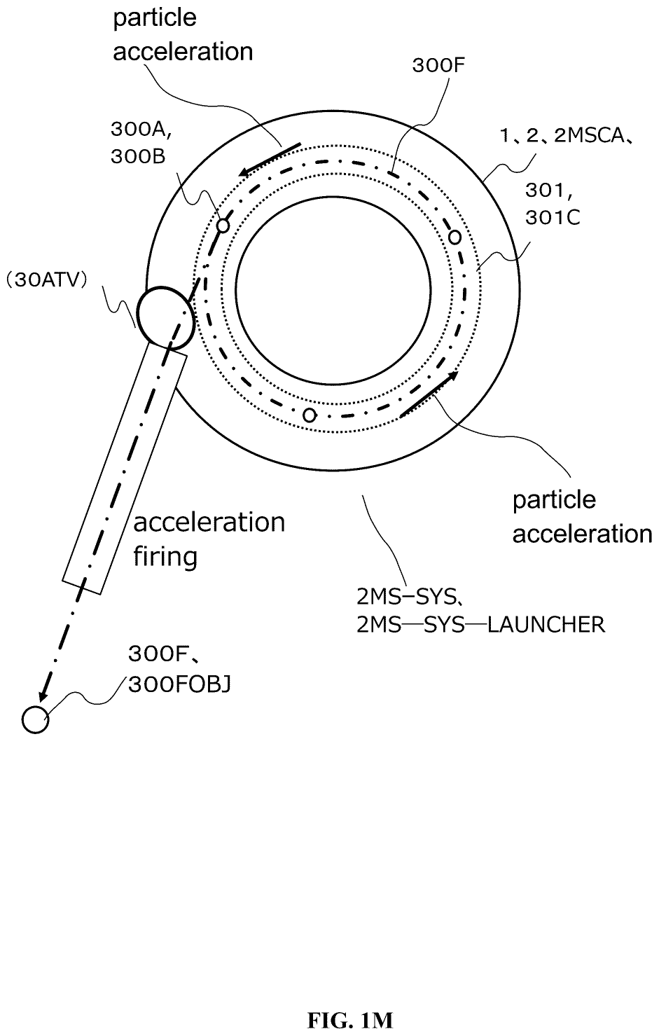

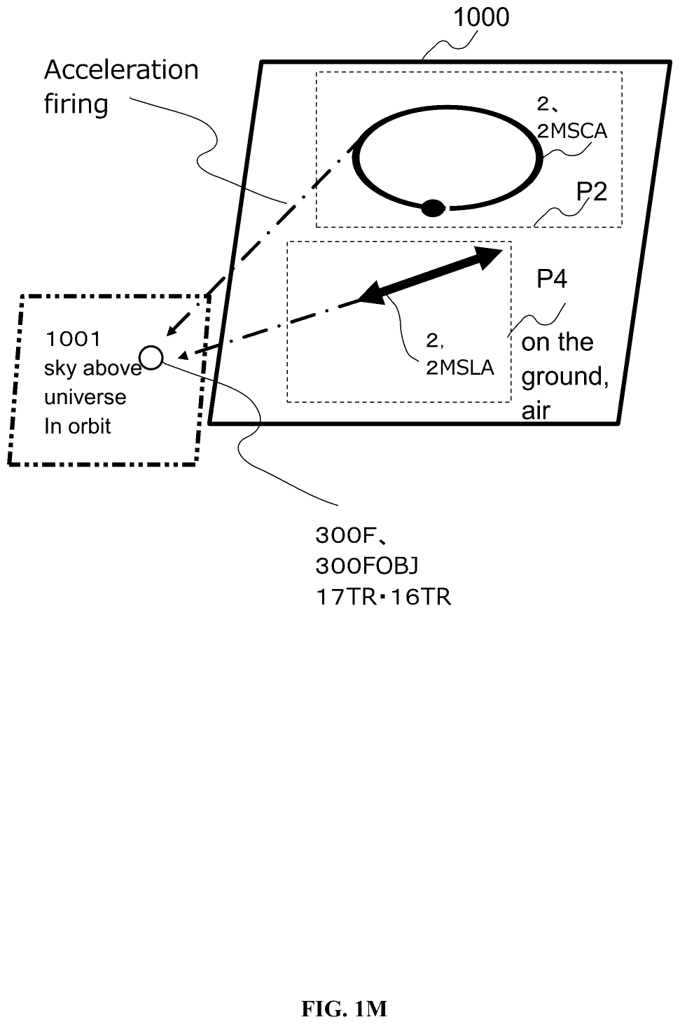

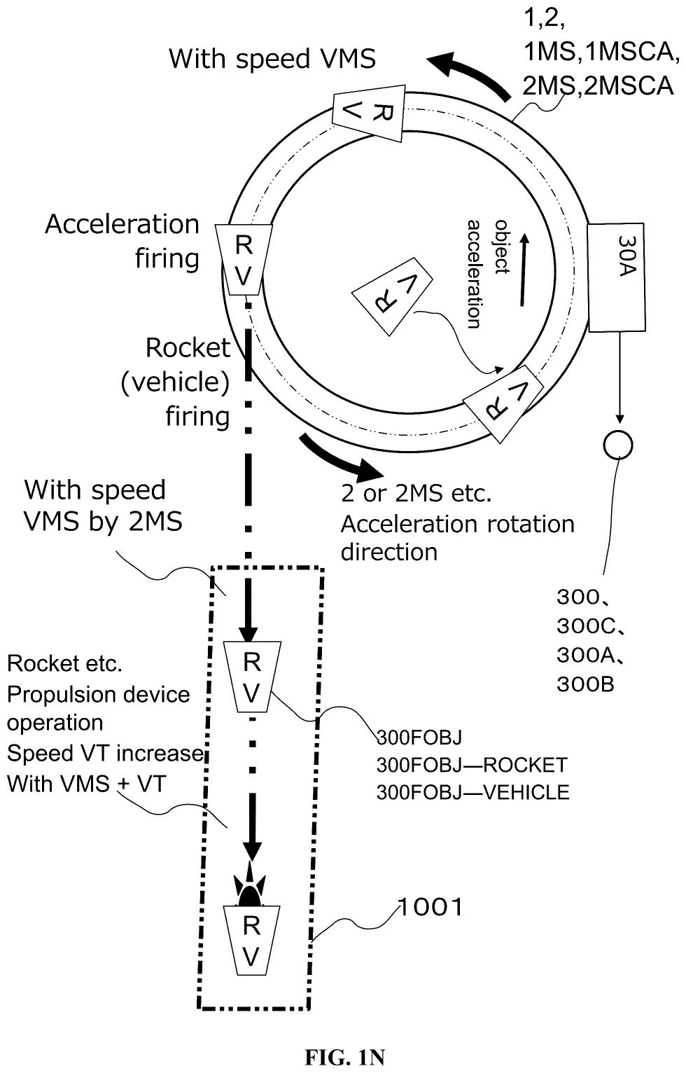

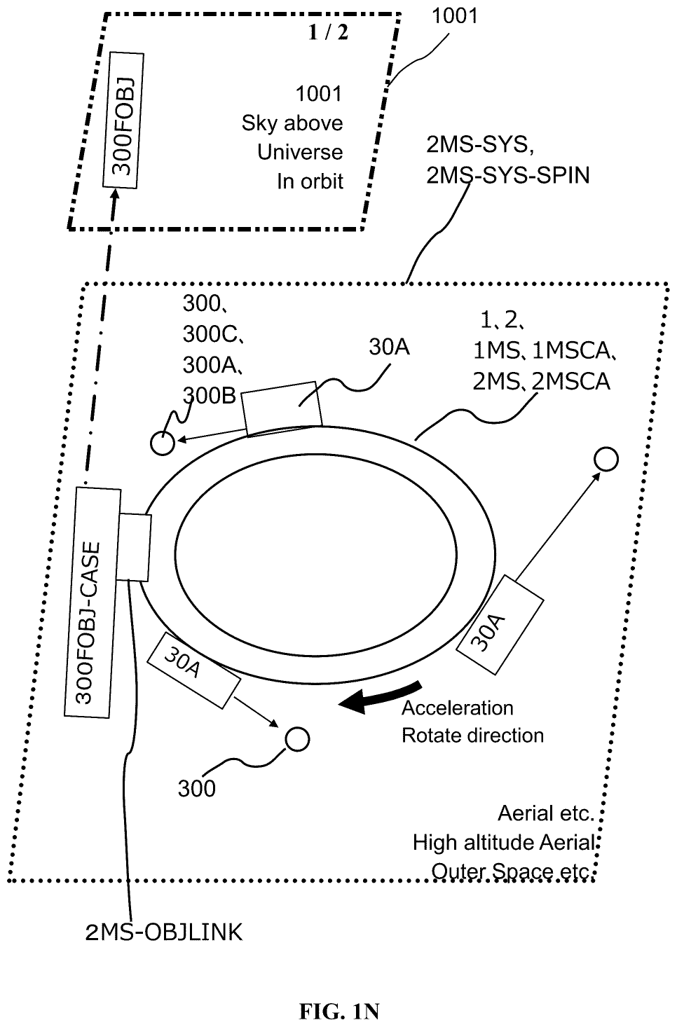

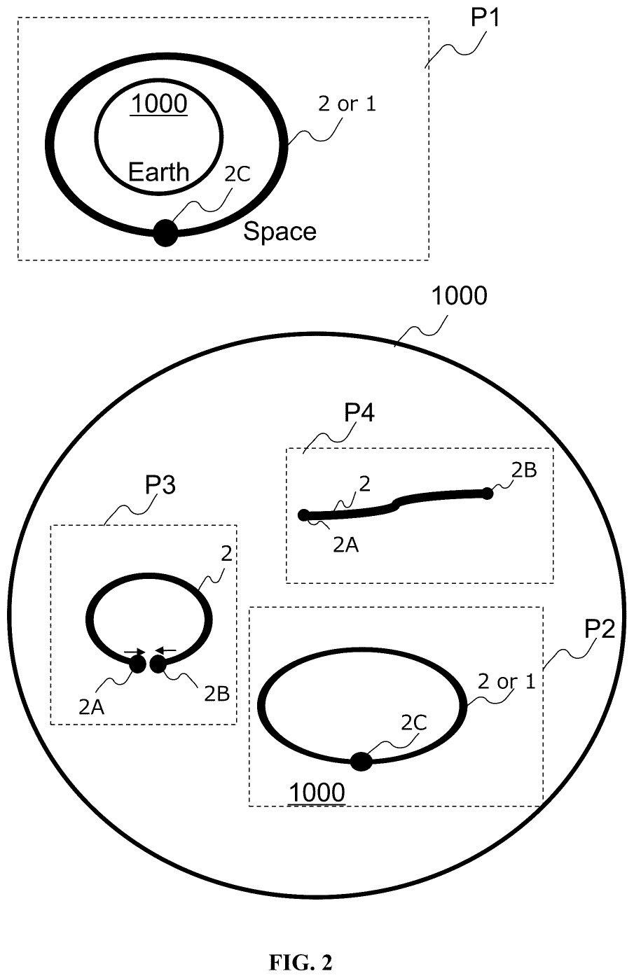

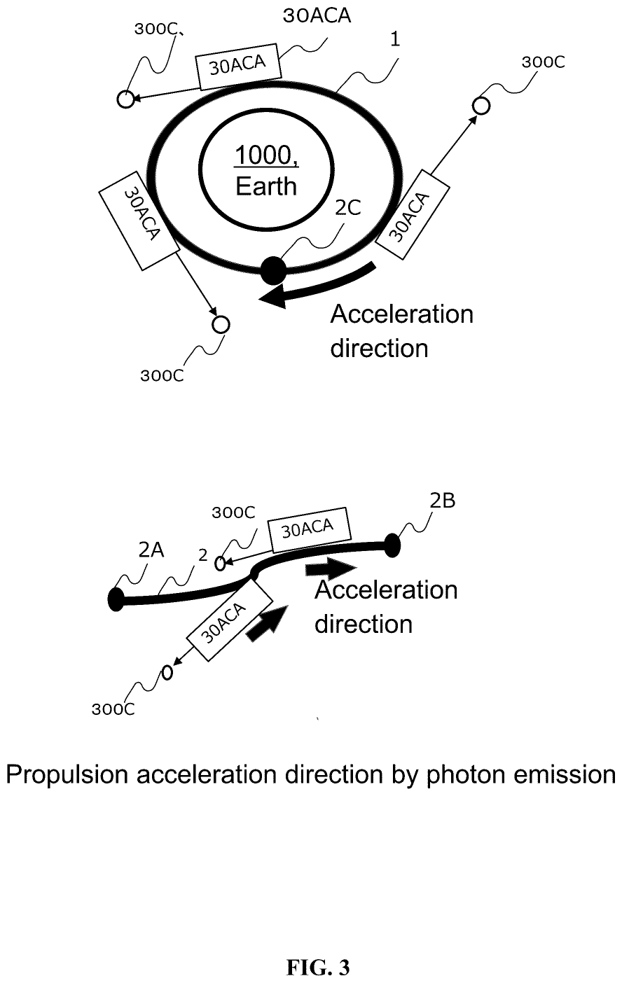

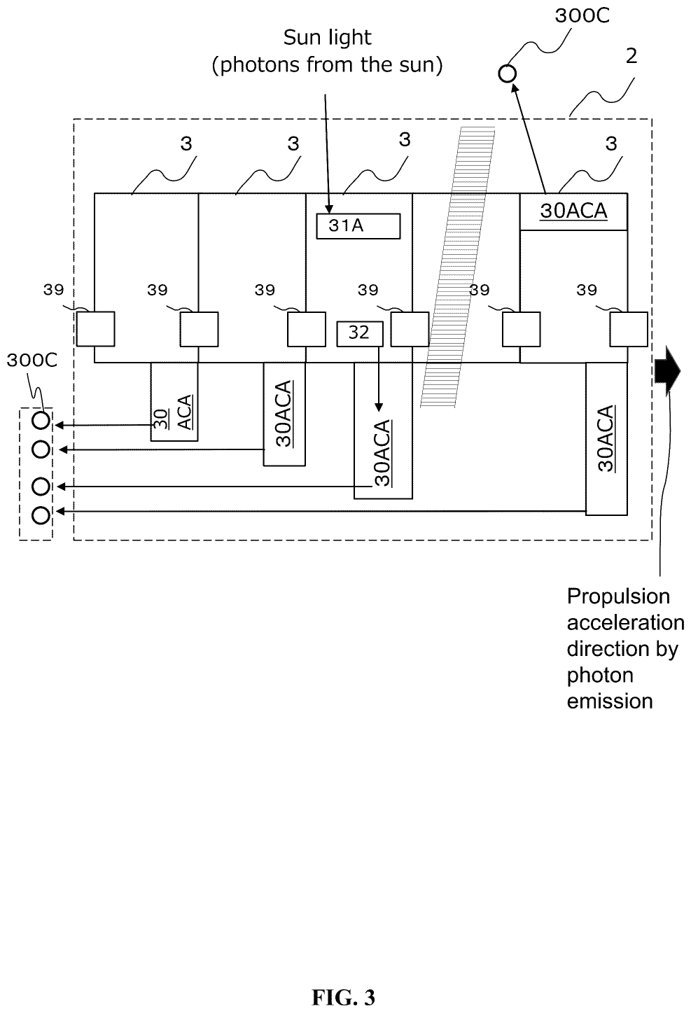

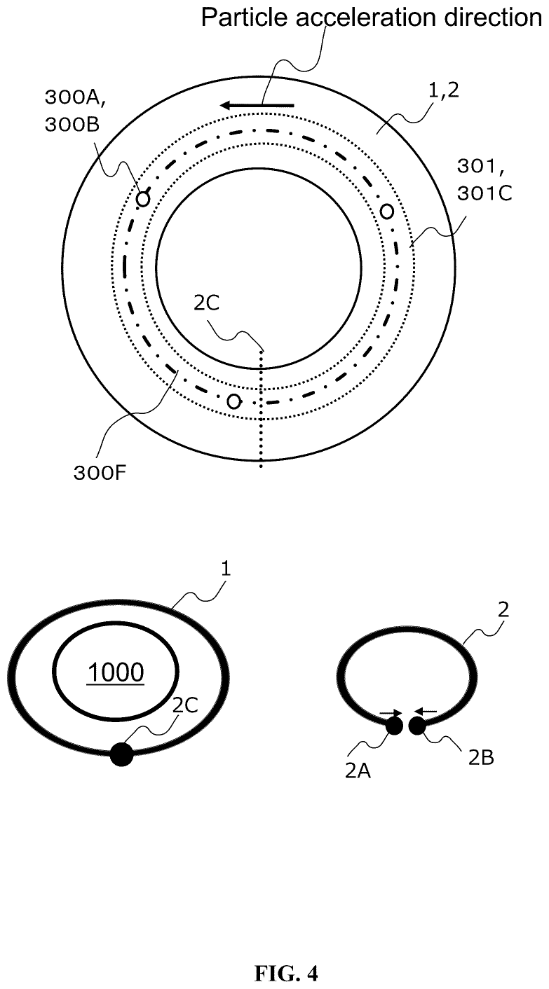

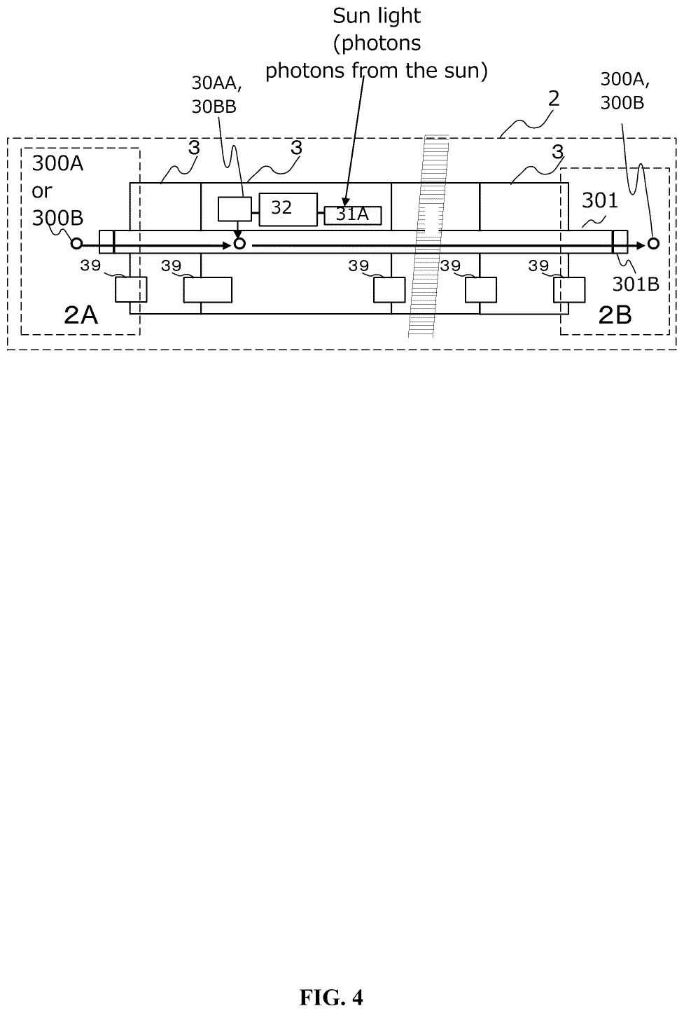

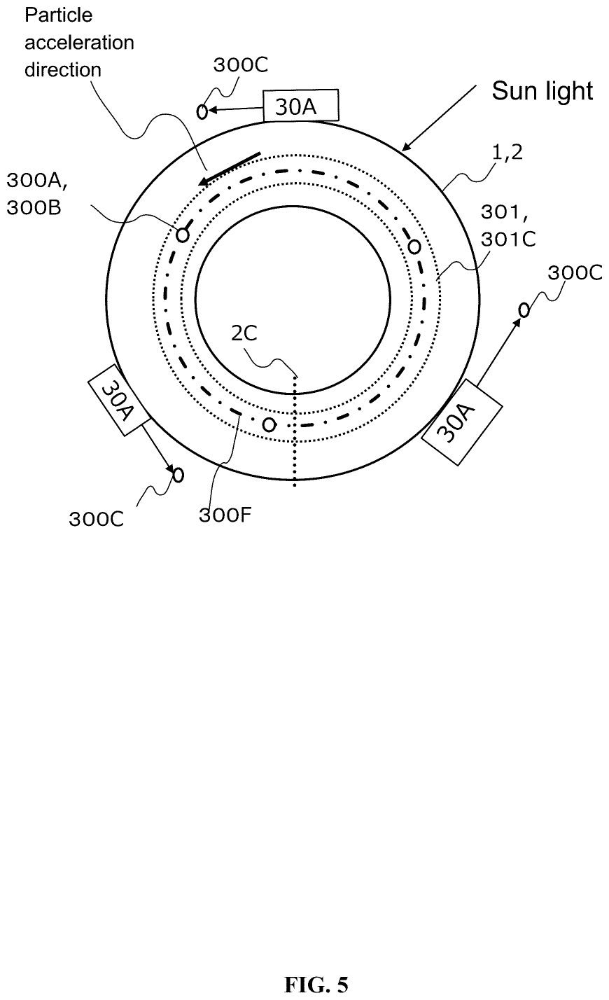

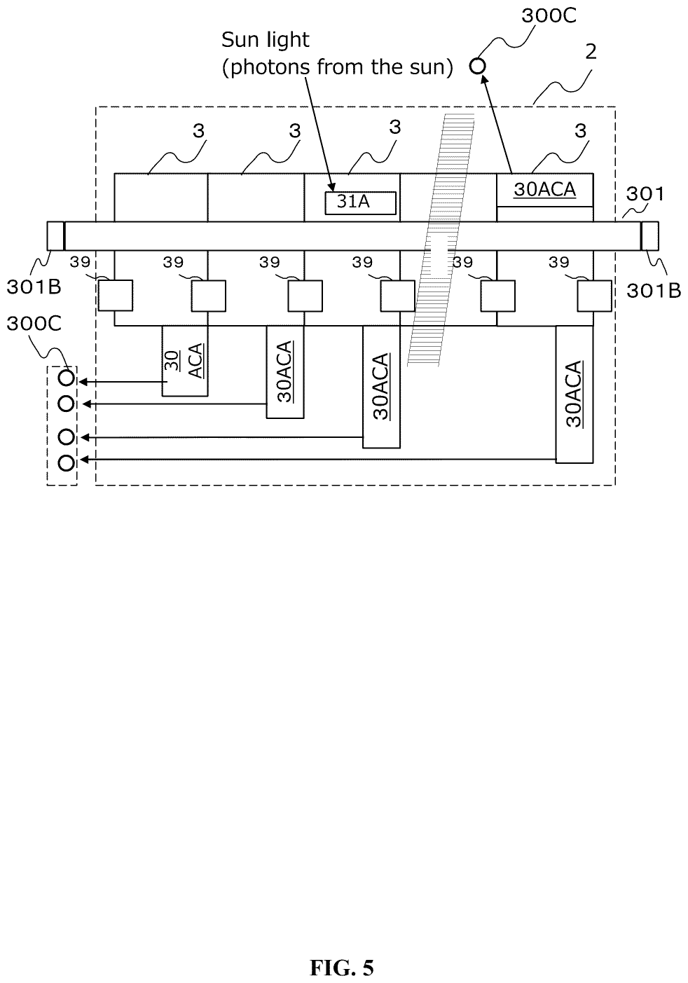

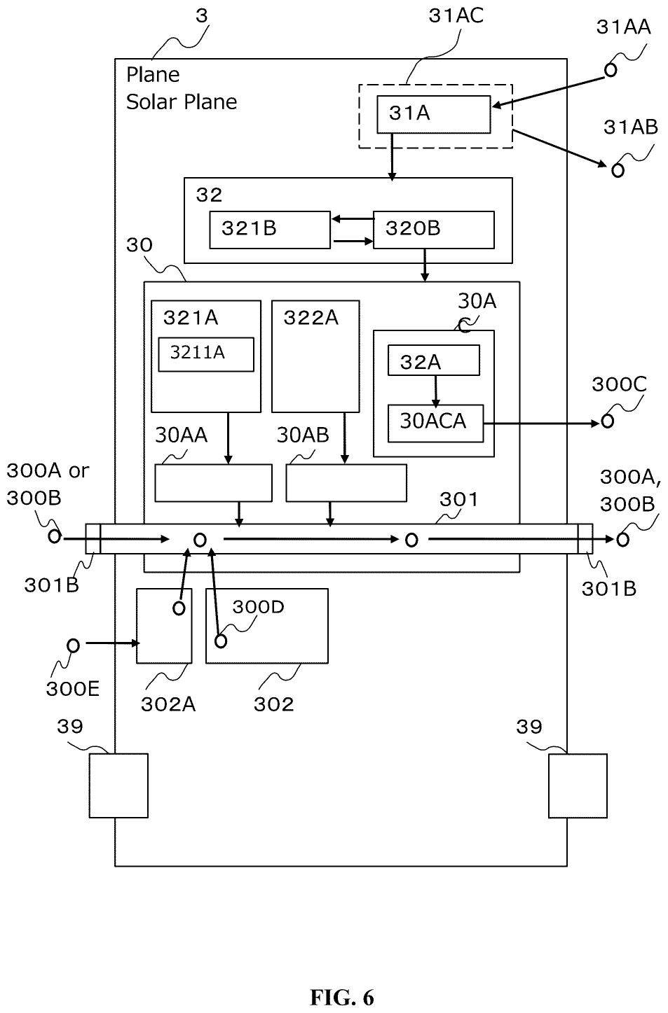

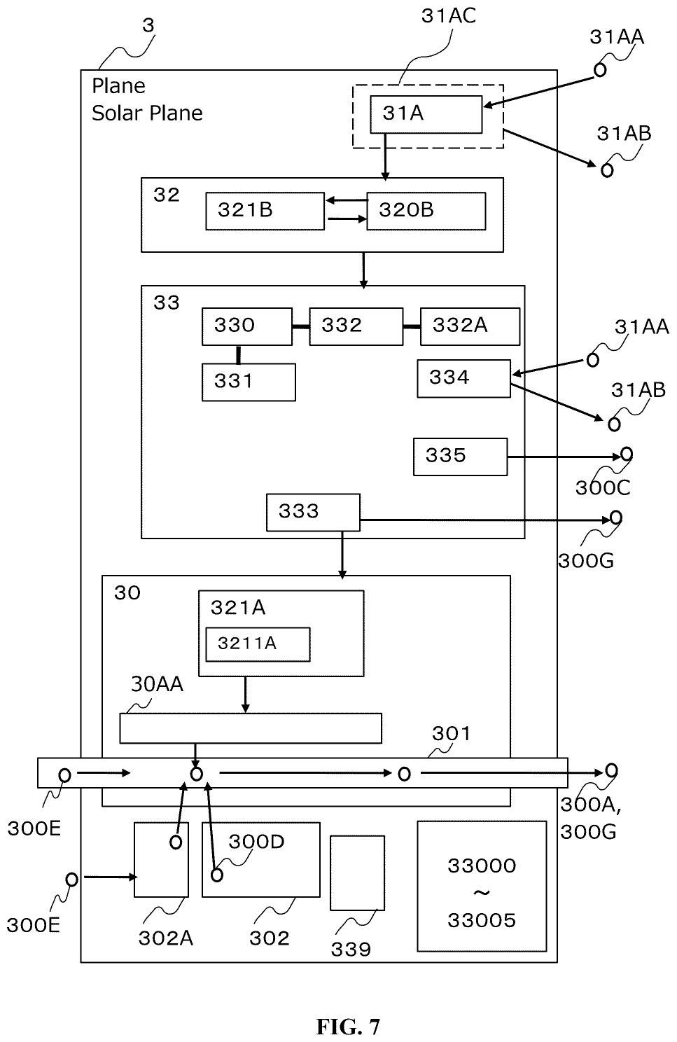

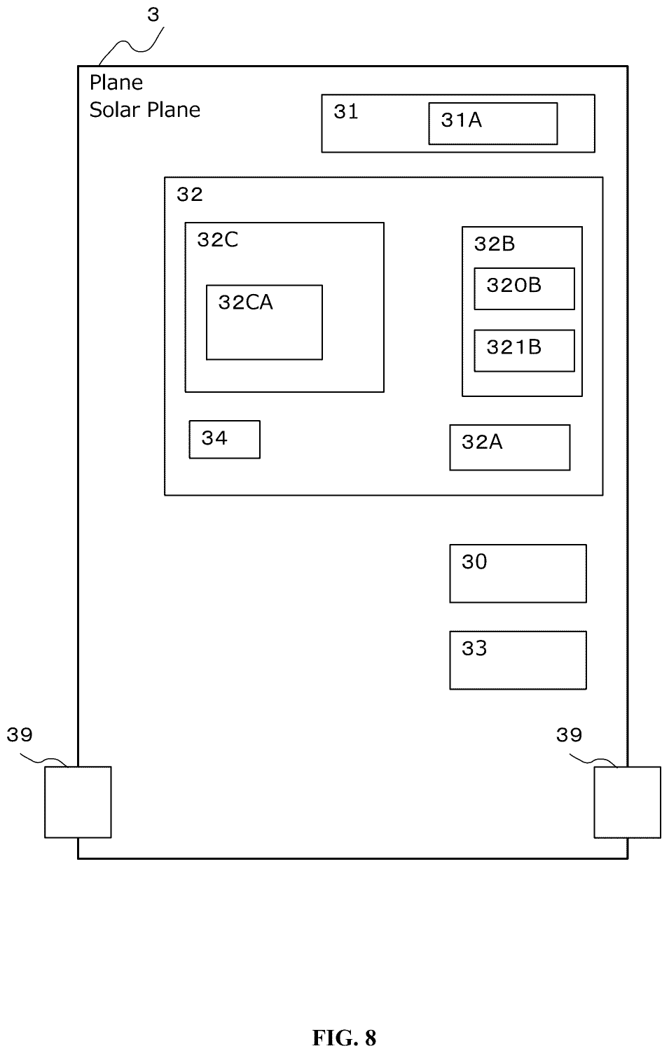

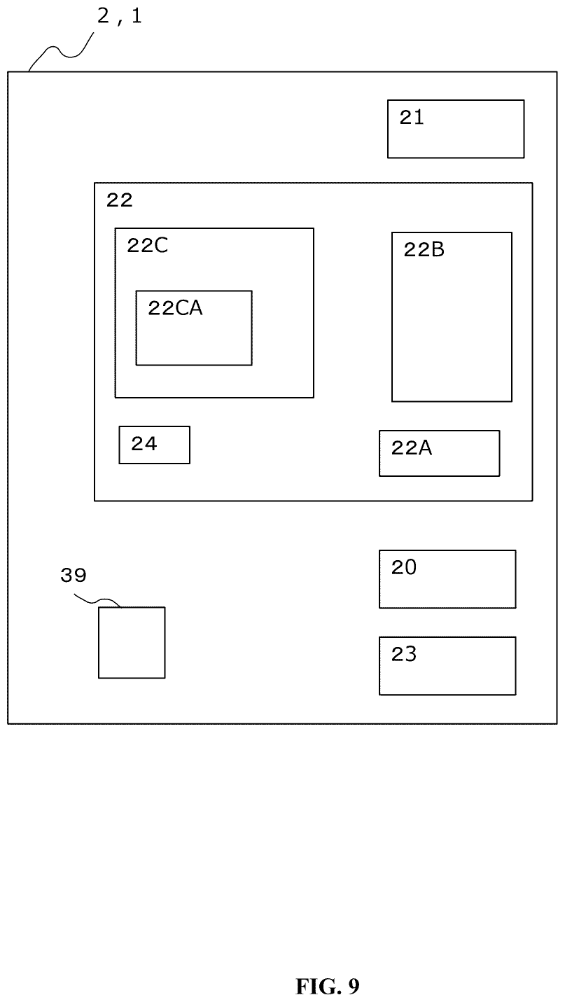

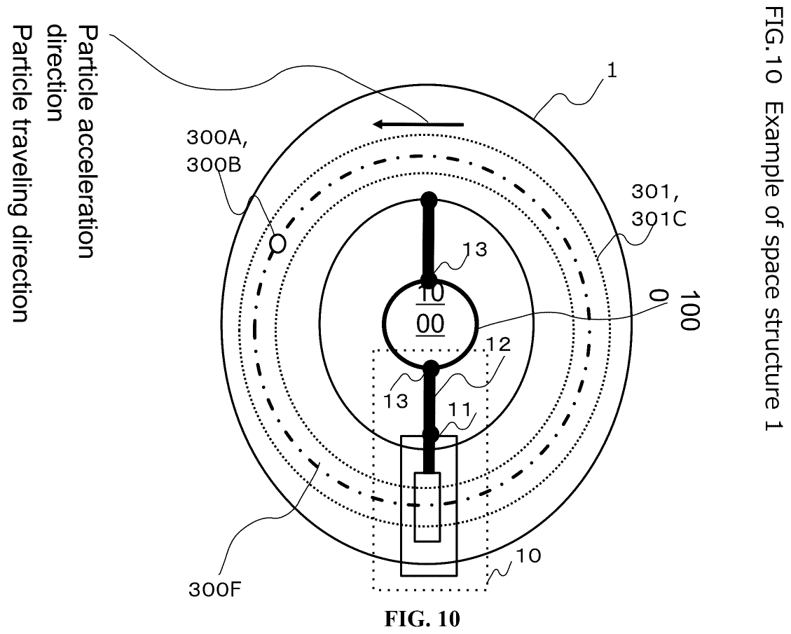

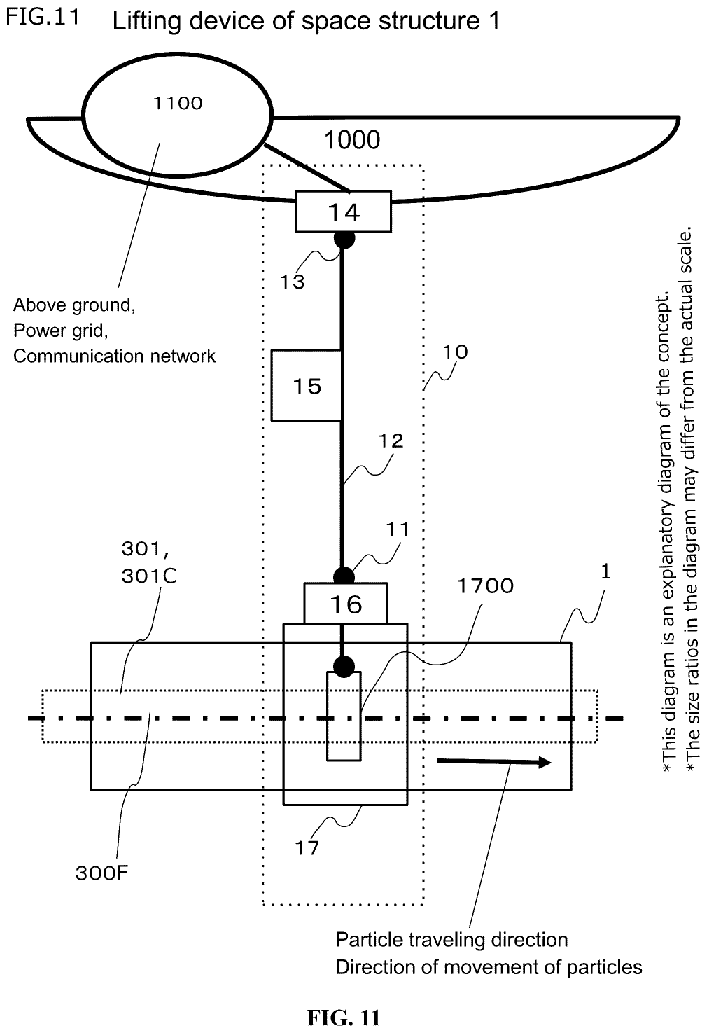

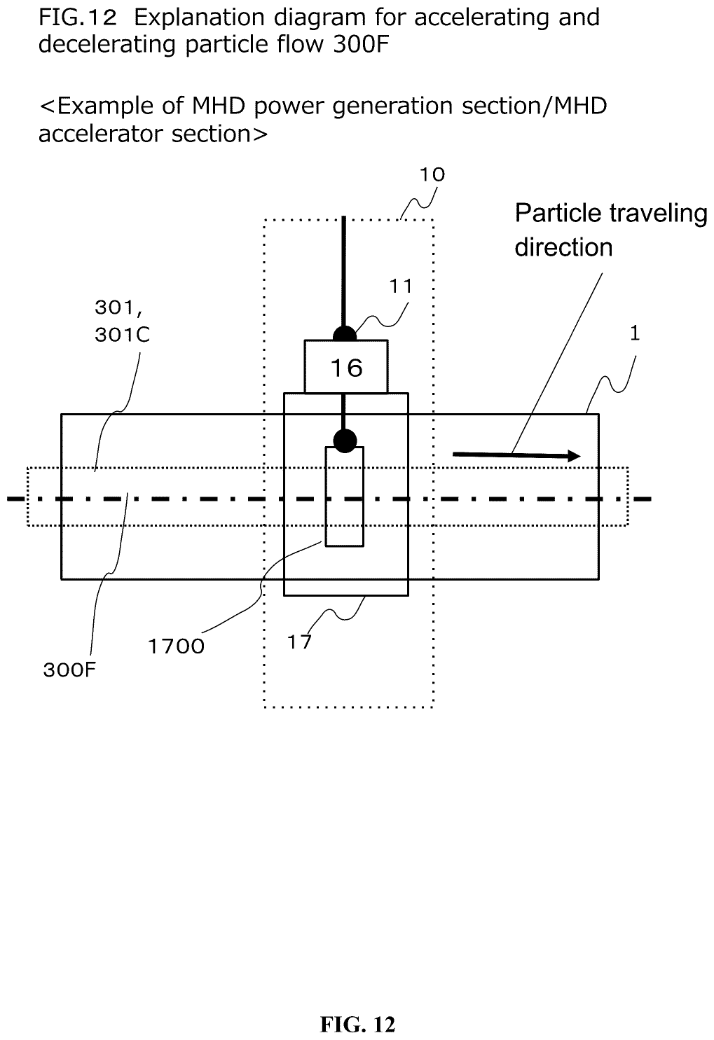

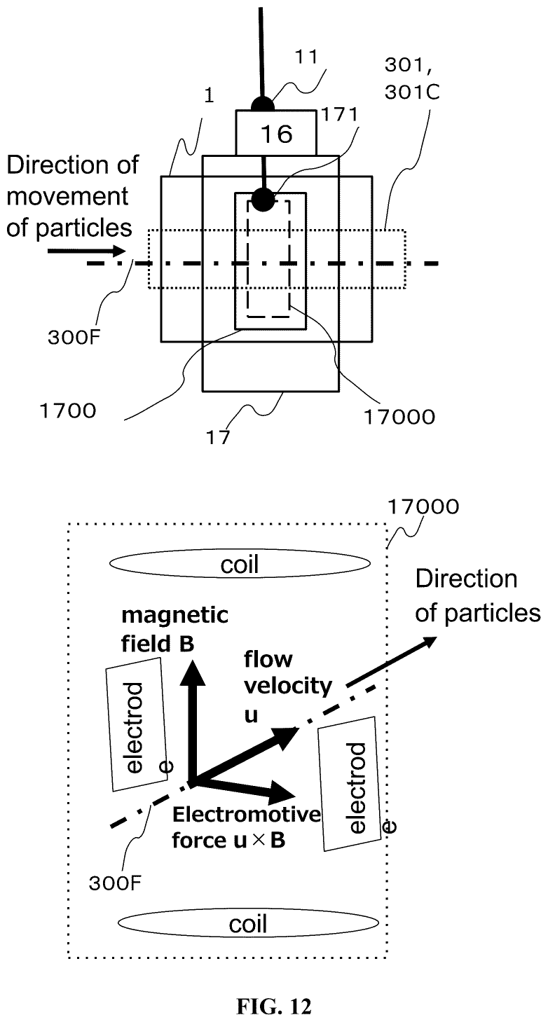

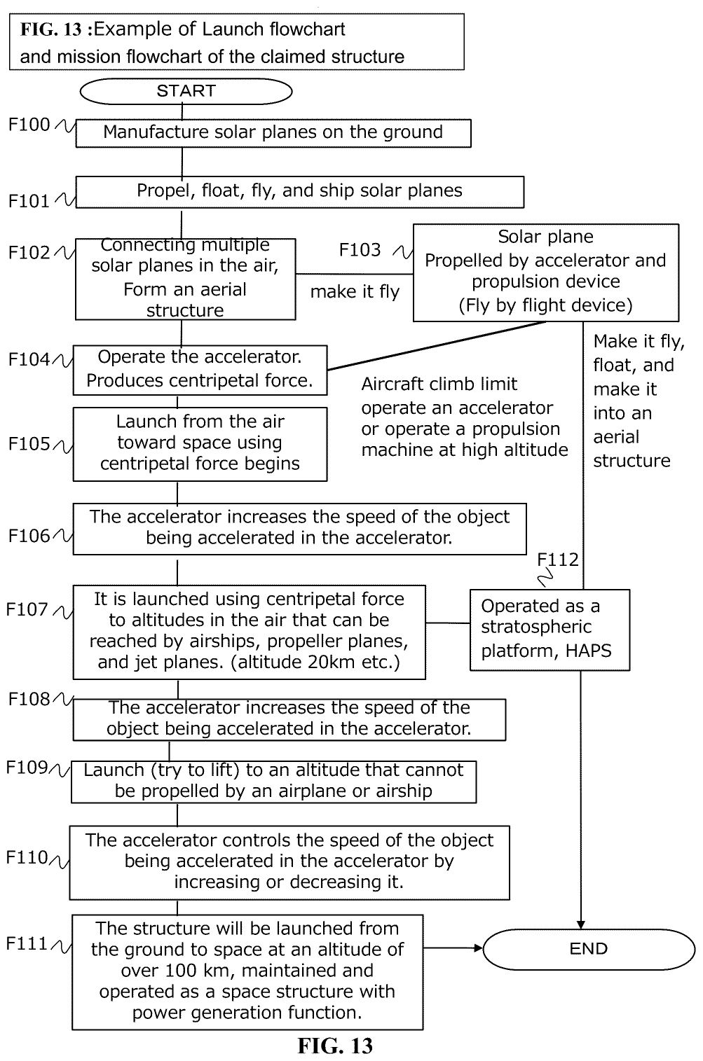

### EXPLANATION OF LETTERS OR NUMERALS

<Launching device> 2MS: A launch device that is characterized by acceleration using photons and charged particles. (or a mass object launcher using the above method), a mass driver, and a transportation system.
2MSLA: 2MS, which includes a linear launcher, mass driver, and transportation system.
2MSCA: 2MS, which includes the annular launcher, mass driver, and transportation system.
2MS-SYS: A system that includes a launcher 2MS (eg 2MSLA, 2MSCA). The whole system.
2MS-SYS-LAUNCHER: A case in which 2MS-SYS launches a launch object 300 FOBJ that is accelerated and rotated using the photon or charged particle method.
2MS-OBJLINK: Device or means for connecting or fixing 300FOBJ to 2MS. <Objects to be launched> 300FOBJ: Objects to be launched.
300FOBJ-ROCKET: When 300FOBJ is a rocket. It can also be a multi-stage rocket.
300FOBJ-VEHICLE: 300FOBJ is a vehicle or transportation device with a rocket or propulsion device. A launched object whose speed can be increased by the accelerator and propulsion device installed inside the 300FOBJ after the 300FOBJ is launched by the launcher. A specific example is the rocket 300FOBJ.
30ATV: Thrust deflection of the accelerator or emitted photon/particle deflection unit, deflection means. Deflection means that controls the direction of launch and thrust. A device that deflects the thrust of an accelerator or deflects emitted photons and particles.
12: Cable. When Structure 2 is used as Structure 2 connected to Plane 3/Solar Plane 3 (Structure 2 which is also HAPS) in the ocean using cable 12, the cable 12 is hung from Structure 2 and connected to Structure 2 via the ladder cable. Cable 12 may enable the input/output and transportation of electric power and communications to Structure 2 and the terrestrial part/power grid. (It may be possible to connect to the device 17. It could be a space elevator-style cable. Or it could be a cable that connects aircraft, airships, aerial structure, platform, HAPS.)
12: Ladder cable section or elevator section, power transmission line, communication line,
13: Ladder cable ground connection section, elevator ground connection section,
14: Ground base section,
15: Lifting device, elevator car section,
16: Skyhook base section, elevator foundation,
16TR: train like part (train body or loading platform) connected to 17,
17: connection part between elevator foundation 16 and structure 2, connector part,
17TR: Train like part (train bogie like part) that can move along structure 2 while being magnetically attracted to it,
17SPACE: Gap between 17 and structures 1 and 2 (gap created by magnetic attraction control, not magnetic levitation) 17SPACE),
171:17 magnetic force generating part, or part that reacts to magnetic force to attract or repel, or magnetic material part, diamagnetic material part,
171C: 17 coil/electromagnet (171C is superconducting electromagnet or electromagnet) May include a magnetic core for the electromagnet, a circuit, etc. (Parts constituting an electromagnet capable of feedback control) (171C is attracted or attracted to 317 and 317C, and 17 and 1 and 2 are prevented from contacting each other.),
171C-SC: superconducting electromagnets type 171C. Includes means to maintain superconductivity (such as a refrigerator).
171 MG: 17 magnetic materials, 171AMG: 17 diamagnetic parts, 171PMG: 17 permanent magnet parts,
171S: Sensor for controlling magnetic attraction to 317 MG, for feedback control,
171E: Electric circuit including 171C and 171S,
171E-wiring: Wiring,
17L: Relay part related to 12 and 17 for connecting the other 2 and 17 pairs,
171T: Propulsion device, propulsion means,
171R: Rocket,
171B: Floating means, balloon, etc. (see FIG. 1F) Means for floating 17 in the lower right figure),
171BP: Deceleration means when 171 falls to the ground (including a parachute; deceleration means when 17 falls from an altitude above the air in the lower right diagram of FIG. 1F),
2: A structure.
22: Electric circuit/wiring of structure 2,
317: Magnetic force generating part on the structure bodies 1 and 2 side, or a part that reacts to magnetic force and attracts or repulses, or a magnetic part, a diamagnetic part, a part that reacts to magnetic force,
317C: Electromagnet parts of structures 1 and 2 that may interact with 171C (built in plane 3, mounted on structures 1 and 2),
317 MG: magnetic parts of structures 1 and 2, 317AMG: diamagnetic parts of structures 1 and 2, 317PMG: permanent magnet part of structures 1 and 2 (317SC: superconducting electromagnet part of structures 1 and 2),
3171S: Magnetic attraction control sensor,
32: Air plain 3 electrical circuit, 32-wiring: wiring,
39: Connecting portion, 39CVR: Cover portion (including extendable cover and slidable cover),
30: Accelerator, 30AA: Linear accelerator using electric field, functional unit, 30AB: Accelerator using magnetic field, functional unit, 30AC: Device that fires and emits photons (photon firing type propulsion device or accelerator), 30ACA: Light emission Elements, laser elements, photon emitting devices, photon emitting accelerators, photon emitting devices, 30X: accelerator and decelerator,
30ATV: Thrust deflection of the accelerator or emitted photon/particle deflection device, deflection means,
3: Air plane,
1001: The target of the launch device. (Such as the sky, outer space, orbit in outer space, etc)
1000: Satellites, celestial bodies,
10: Idea of lifting device, space elevator, Jacob's Ladders like part. Orbital elevator like section,

### RELATED APPLICATIONS, INCORPORATION BY REFERENCE

“This application claims the benefit of foreign priority to Japanese Patent Application No. JP2022-015274, filed Feb. 2, 2022, which is incorporated by reference in its entirety.”

“This application claims the benefit of foreign priority to PCT Application No. PCT/JP2022/014751, filed Apr. 13, 2022, which is incorporated by reference in its entirety.”

“This application claims the benefit of foreign priority to Japanese Patent Application No. JP2022-086263, filed May 26, 2022, which is incorporated by reference in its entirety.”

“This application claims the benefit of foreign priority to Japanese Patent Application No. JP2022-181631, filed Nov. 14, 2022, which is incorporated by reference in its entirety.”

“This application claims the benefit of foreign priority to PCT Application No. PCT/JP2022/047797, filed Dec. 25, 2022, which is incorporated by reference in its entirety.”

“This application claims the benefit of foreign priority to Japanese Patent Application No. JP2022-123161, filed Aug. 2, 2022, which is incorporated by reference in its entirety.”

“This application claims the benefit of foreign priority to Japanese Patent Application No. JP2023-007722, filed Jan. 22, 2023, which is incorporated by reference in its entirety.”

“This application claims the benefit of foreign priority to Japanese Patent Application No. JP2023-063114, filed Apr. 9, 2023, which is incorporated by reference in its entirety.”

“This application claims the benefit of foreign priority to PCT Application No. PCT/JP2023/016185, filed Apr. 24, 2023, which is incorporated by reference in its entirety.”

“This application claims the benefit of foreign priority to PCT Application No. PCT/JP2023/017215, filed May 7, 2023, which is incorporated by reference in its entirety.”

“This application claims the benefit of foreign priority to Japanese Patent Application No. JP2023-150635, filed Sep. 18, 2023, which is incorporated by reference in its entirety.”

“This application claims the benefit of foreign priority to Japanese Patent Application No. JP2023-151787, filed Sep. 19, 2023, which is incorporated by reference in its entirety.”

“This application claims the benefit of foreign priority to Japanese Patent Application No. JP2023-174791, filed Oct. 6, 2023, which is incorporated by reference in its entirety.”

“This application claims the benefit of foreign priority to Japanese Patent Application No. JP2023-174037, filed Oct. 6, 2023, which is incorporated by reference in its entirety.”

“This application claims the benefit of foreign priority to Japanese Patent Application No. JP2023-174180, filed Oct. 6, 2023, which is incorporated by reference in its entirety.”

“This application claims the benefit of foreign priority to Japanese Patent Application No. JP2023-196029, filed Nov. 17, 2023, which is incorporated by reference in its entirety.”

“This application claims the benefit of foreign priority to Japanese Patent Application No. JP2023-196327, filed Nov. 19, 2023, which is incorporated by reference in its entirety.”

“This application claims the benefit of foreign priority to Japanese Patent Application No. JP2024-011380, filed Jan. 29, 2024, which is incorporated by reference in its entirety.”

“This application claims the benefit of foreign priority to Japanese Patent Application No. JP2024-058388, filed Mar. 31, 2024, which is incorporated by reference in its entirety.”

“This application claims the benefit of foreign priority to Japanese Patent Application No. JP2024-065053, filed Apr. 14, 2024, which is incorporated by reference in its entirety.”

“This application claims the benefit of foreign priority to Japanese Patent Application No. JP2024-072096, filed Apr. 26, 2024, which is incorporated by reference in its entirety.”

“This application claims the benefit of foreign priority to PCT Application No. PCT/JP2024/016620, filed Apr. 28, 2024, which is incorporated by reference in its entirety.”

“This application claims the benefit of foreign priority to Japanese Patent Application No. JP2024-082974, filed May 22, 2024, which is incorporated by reference in its entirety.”

“This application claims the benefit of foreign priority to Japanese Patent Application No. JP2024-122912, filed Jul. 29, 2024, which is incorporated by reference in its entirety.”

“This application claims the benefit of foreign priority to Japanese Patent Application No. JP2024-123704, filed Jul. 30, 2024, which is incorporated by reference in its entirety.”

What is claimed is:

1. A launcher comprising:
The launcher accelerates projectile using recoil or reaction that moves, or emits, or reflects photons or synchrotron radiation photons or charged particles.

2. A launcher according to claim 1, further comprising:
The launcher has a feature that the projectile can be launched, or ejected, or released from the launcher after the accelerates.

3. A launcher according to claim 1, further comprising:
The launcher accelerates projectile of the launcher by recoil or reaction due to radiation or reflection of synchrotron radiation,
The launcher has synchrotron radiation generator which using particle accelerator,
The photons is synchrotron radiation photons.

4. A launcher according to claim 3, further comprising:
The launcher has a feature that the projectile can be launched, or ejected, or released from the launcher after the accelerates.

5. A launcher according to claim 2, further comprising:
The launcher accelerates projectile using annular acceleration trajectory.

6. A launcher according to claim 5, further comprising:
The launcher accelerates projectile of the launcher by recoil or reaction due to radiation or reflection of synchrotron radiation,
The launcher has synchrotron radiation generator which using particle accelerator,
The photons is synchrotron radiation photons.
